(19) United States
(12) Patent Application Publication
(10) Pub. No.: US 2025/0174038 A1
(43) Pub. Date: May 29, 2025

(54) DISPLAY DEVICE

(71) Applicant: Samsung Display Co., Ltd., Yongin-si (KR)

(72) Inventors: HYUNDAE LEE, Yongin-si (KR); TAEKYUNG AHN, Yongin-si (KR); HYO-CHUL LEE, Yongin-si (KR); HYANG-A PARK, Yongin-si (KR); KANGBIN JO, Yongin-si (KR)

(21) Appl. No.: 18/917,681

(22) Filed: Oct. 16, 2024

(30) Foreign Application Priority Data
Nov. 28, 2023 (KR) 10-2023-0167724

(51) Int. Cl. G06V 40/13; G06F 3/044; G09G 3/32

(52) U.S. Cl. CPC G06V 40/1318; G06F 3/0443; G09G 3/32; G09G 2300/0819; G09G 2300/0842; G09G 2310/061; G09G 2354/00; G09G 2360/145

(57) ABSTRACT

A display device including: a display panel including a display region and a non-display region, a plurality of pixels and a plurality of sensors being in the display region, wherein each of the plurality of pixels includes: a light emitting element; and a pixel drive circuit connected to the light emitting element, wherein the plurality of sensors includes first sensors in a first region of the display region and second sensors in a second region of the display region, wherein each of the first sensors includes: a first light receiving element; and a first sensor drive circuit electrically connected to the first light receiving element, and wherein each of the second sensors includes: a second light receiving element; and a second sensor drive circuit electrically isolated from the second light receiving element.

### CROSS-REFERENCE TO RELATED APPLICATION

The present application claims priority to and the benefit of Korean Patent Application No. 10-2023-0167724, filed on Nov. 28, 2023, in the Korean Intellectual Property Office, the entire disclosure of which is incorporated by reference herein.

### BACKGROUND

### 1. Field

One or more embodiments of the present disclosure described herein relate to a display device having a biometric information recognition function.

### 2. Description of the Related Art

A display device provides various functions that enable a user to interact with the display device. For example, the display device may display an image to provide information to the user, or may sense a user input. Recent display devices include a function for sensing biometric information of a user.

The biometric information may be recognized by using a capacitive sensing technique for sensing a change in capacitance between electrodes, a light sensing technique for sensing incident light using an optical sensor, or an ultrasonic sensing technique for sensing vibration using a piezoelectric element.

### SUMMARY

One or more embodiments of the present disclosure provide a display device with improved biometric information recognition performance.

According to one or more embodiments, a display device includes a display panel including a display region and a non-display region, a plurality of pixels and a plurality of sensors being in the display region.

Each of the plurality of pixels includes a light emitting element and a pixel drive circuit connected to the light emitting element. The plurality of sensors include first sensors in a first region of the display region and second sensors in a second region of the display region.

Each of the first sensors includes a first light receiving element and a first sensor drive circuit electrically connected to the first light receiving element, and each of the second sensors includes a second light receiving element and a second sensor drive circuit electrically isolated from the second light receiving element.

Each of the first and second sensor drive circuits includes a reset transistor connected between a reset voltage line and a sensing node, an amplifying transistor connected to a sensor drive voltage line, and an output transistor connected between the amplifying transistor and a readout line. The first light receiving element is electrically connected to the sensing node of the first sensor drive circuit, and the second light receiving element is electrically isolated from the second sensor drive circuit at the sensing node of the second sensor drive circuit.

The reset transistor includes a first electrode connected to the reset voltage line, a second electrode connected with the sensing node, and a third electrode configured to receive a reset control signal. The amplifying transistor includes a first electrode connected to the sensor drive voltage line, a second electrode connected with the output transistor, and a third electrode connected with the sensing node. The output transistor includes a first electrode connected with the second electrode of the amplifying transistor, a second electrode connected with the readout line, and a third electrode configured to receive an output control signal.

A first effective connecting electrode is at the sensing node of the first sensor drive circuit to electrically connect the second electrode of the reset transistor and the third electrode of the amplifying transistor. A first ineffective connecting electrode is at the sensing node of the second sensor drive circuit and is not connected to at least one of the second electrode of the reset transistor or the third electrode of the amplifying transistor.

The display panel further includes a first intermediate connecting electrode connected to the third electrode of the amplifying transistor of the first sensor drive circuit, a second intermediate connecting electrode connected to the third electrode of the amplifying transistor of the second sensor drive circuit, and a first via insulating layer. The first effective connecting electrode and the first ineffective connecting electrode are on the first via insulating layer, the first via insulating layer is on the first and second intermediate connecting electrodes.

A first effective contact hole exposing the first intermediate connecting electrode is in the first via insulating layer, and the first effective connecting electrode is connected to the first intermediate connecting electrode through the first effective contact hole. The second intermediate connecting electrode is completely covered by the first via insulating layer without being exposed through a contact hole.

A second effective connecting electrode connected to the first effective connecting electrode is further located at the sensing node of the first sensor drive circuit. A second ineffective connecting electrode connected to the first ineffective connecting electrode is further located at the sensing node of the second sensor drive circuit.

The first light receiving element includes an effective anode electrode connected with the second effective connecting electrode of the first sensor drive circuit. The second light receiving element includes an ineffective anode electrode connected with the second ineffective connecting electrode of the second sensor drive circuit.

A first effective connecting electrode is at the sensing node of the first sensor drive circuit and connects the second electrode of the reset transistor and the third electrode of the amplifying transistor. A first ineffective connecting electrode is at the sensing node of the second sensor drive circuit, and connects the second electrode of the reset transistor and the third electrode of the amplifying transistor.

A second effective connecting electrode connected to the first effective connecting electrode is at the sensing node of the first sensor drive circuit. A second ineffective connecting electrode not connected to the first ineffective connecting electrode is at the sensing node of the second sensor drive circuit.

The display panel further includes a second via insulating layer, the second effective connecting electrode and the second ineffective connecting electrode being on the second via insulating layer, the second via insulating layer being on the first effective connecting electrode and the first ineffective connecting electrode.

A second effective contact hole exposing the first effective connecting electrode is in the second via insulating layer, and the second effective connecting electrode is connected to the first effective connecting electrode through the second effective contact hole. The first ineffective connecting electrode is completely covered by the second via insulating layer without being exposed through a contact hole.

The first light receiving element includes an effective anode electrode connected with the second effective connecting electrode of the first sensor drive circuit. The second light receiving element includes an ineffective anode electrode connected with the second ineffective connecting electrode of the second sensor drive circuit.

The sensing node of the first sensor drive circuit includes a first effective connecting electrode connecting the second electrode of the reset transistor and the third electrode of the amplifying transistor. The sensing node of the second sensor drive circuit includes a first ineffective connecting electrode connecting the second electrode of the reset transistor and the third electrode of the amplifying transistor.

The sensing node of the first sensor drive circuit further includes a second effective connecting electrode connected to the first effective connecting electrode. The sensing node of the second sensor drive circuit further includes a second ineffective connecting electrode connected to the first ineffective connecting electrode.

The first light receiving element includes an effective anode electrode connected with the second effective connecting electrode of the first sensor drive circuit. The second light receiving element includes an ineffective anode electrode not connected with the second ineffective connecting electrode of the second sensor drive circuit.

The display panel further includes a third via insulating layer, the effective anode electrode and the ineffective anode electrode are on the third via insulating layer, the third via insulating layer being on the second effective connecting electrode and the second ineffective connecting electrode. A third effective contact hole exposing the second effective connecting electrode is in the third via insulating layer, and the effective anode electrode is connected to the second effective connecting electrode through the third effective contact hole. The second ineffective connecting electrode is completely covered by the third via insulating layer without being exposed through a contact hole.

The reset voltage line is commonly connected to the first and second sensor drive circuits. The reset transistors of the first and second sensor drive circuits are concurrently turned on during a reset period. A reset voltage applied to the reset voltage line is applied to the sensing node through the turned-on reset transistors during the reset period.

The first region is a sensing region configured to sense biometric information, the second region is a non-sensing region configured so as not to sense the biometric information. The second region includes a first non-sensing region on a first side of the first region, and a second non-sensing region on a second side of the first region, the second side facing away from the first side of the first region.

The display panel further includes readout lines connected to the sensors. The display device further includes a readout chip electrically connected to effective readout lines from among the readout lines. The effective readout lines are in the first region and connected to the first sensors.

The readout chip is not electrically connected with ineffective readout lines from among the readout lines, the ineffective readout lines are in the second region and connected to the second sensors.

### BRIEF DESCRIPTION OF THE DRAWINGS

The above and other aspects and features of the present disclosure will become apparent by describing in detail embodiments thereof with reference to the accompanying drawings.

FIG. 1 is a perspective view of a display device according to one or more embodiments of the present disclosure.

FIG. 2A is an exploded perspective view of the display device according to one or more embodiments of the present disclosure.

FIG. 2B is a sectional view of the display device according to one or more embodiments of the present disclosure.

FIG. 3A is a plan view of a display module according to one or more embodiments of the present disclosure.

FIG. 3B is a block diagram of the display device according to one or more embodiments of the present disclosure.

FIG. 4A is a circuit diagram illustrating a pixel and an effective sensor disposed in a sensing region and a pixel and an ineffective sensor disposed in a non-sensing region according to one or more embodiments of the present disclosure.

FIG. 4B is a waveform diagram for explaining operation of the pixel illustrated in FIG. 4A.

FIG. 4C is a waveform diagram for explaining operation of the effective sensor illustrated in FIG. 4A.

FIG. 5 is a plan view illustrating a display panel according to one or more embodiments of the present disclosure.

FIG. 6A is a sectional view illustrating a portion of a pixel and a portion of an effective sensor disposed in the sensing region according to one or more embodiments of the present disclosure.

FIG. 6B is a sectional view illustrating a portion of a pixel and a portion of an ineffective sensor disposed in the non-sensing region according to one or more embodiments of the present disclosure.

FIGS. 7A and 7B are sectional views illustrating a portion of a pixel and a portion of an ineffective sensor disposed in the non-sensing region according to one or more embodiments of the present disclosure.

FIGS. 8A-8J are plan views illustrating a stacking process of a circuit layer according to one or more embodiments of the present disclosure.

FIGS. 9A and 9B are sectional views illustrating light emitting elements and an effective light receiving element of the display panel according to one or more embodiments of the present disclosure.

### DETAILED DESCRIPTION

In this specification, when it is mentioned that a component (or, a region, a layer, a part, etc.) is referred to as being “on”, “connected to” or “coupled to” another component, this means that the component may be directly on, connected to, or coupled to the other component or a third component may be present therebetween.

Identical reference numerals refer to identical components. Additionally, in the drawings, the thicknesses, proportions, and dimensions of components are exaggerated for effective description. As used herein, the term “and/or” includes all of one or more combinations defined by related components.

Terms such as first, second, and the like may be used to describe various components, but the components should not be limited by the terms. The terms may be used only for distinguishing one component from other components. For example, without departing the spirit and scope of the present disclosure, a first component may be referred to as a second component, and similarly, the second component may also be referred to as the first component. The terms of a singular form may include plural forms unless otherwise specified.

In addition, terms such as “below”, “under”, “above”, and “over” are used to describe a relationship of components illustrated in the drawings. The terms are relative concepts and are described based on directions illustrated in the drawing.

It should be understood that terms such as “comprise”, “include”, and “have”, when used herein, specify the presence of stated features, numbers, steps, operations, components, parts, or combinations thereof, but do not preclude the presence or addition of one or more other features, numbers, steps, operations, components, parts, or combinations thereof.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

As used herein, the term “and/or” includes any and all combinations of one or more of the associated listed items. As used herein, “A and/or B” represents the case of A, B, or A and B. Also, “at least one of A and B” represents the case of A, B, or A and B. Throughout the present disclosure, the expression “at least one of a, b or c” or “at least one of a, b, and c” indicates only a, only b, only c, both a and b, both a and c, both b and c, all of a, b, and c, or variations thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Hereinafter, embodiments of the present disclosure will be described with reference to the accompanying drawings.

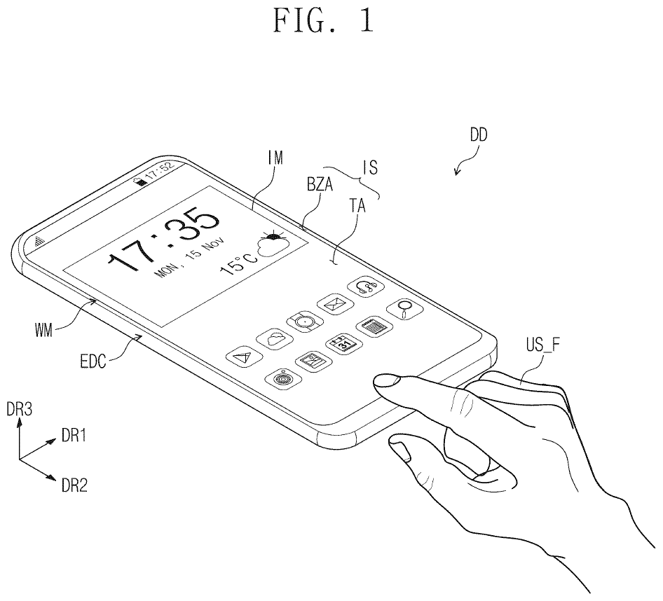

FIG. 1 is a perspective view of a display device according to one or more embodiments of the present disclosure.

Referring to FIG. 1, the display device DD according to one or more embodiments of the present disclosure may have a rectangular shape with short sides parallel to a first direction DR1 and long sides parallel to a second direction DR2 crossing the first direction DR1. However, without being limited thereto, the display device DD may have various shapes such as a circular shape, a polygonal shape, and/or the like.

The display device DD may be a device activated depending on an electrical signal. The display device DD may include various embodiments. For example, the display device DD may be applied to electronic devices such as a smart watch, a tablet computer, a notebook computer, a computer, a smart television, and/or the like.

Hereinafter, a normal direction substantially perpendicular to a plane defined by the first direction DR1 and the second direction DR2 is defined as a third direction DR3. The expression “when viewed from above the plane” used herein may mean that it is viewed in the third direction DR3 or “in a plan view”.

The upper surface of the display device DD may be defined as a display surface IS and may be parallel to the plane defined by the first direction DR1 and the second direction DR2. Images IM generated by the display device DD may be provided to a user through the display surface IS.

The display surface IS may be divided into a transmissive region TA and a bezel region BZA. The transmissive region TA may be a region on which the images IM are displayed. The user visually recognizes the images IM through the transmissive region TA. In this embodiment, the transmissive region TA is illustrated in a rounded quadrangular shape. However, this is illustrative, and the transmissive region TA may have various shapes and is not limited to any one embodiment.

The bezel region BZA is adjacent to the transmissive region TA. The bezel region BZA may have a certain color. The bezel region BZA may be around (e.g., may surround) the transmissive region TA along an edge or a periphery of the transmissive region TA. Accordingly, the shape of the transmissive region TA may be substantially defined by the bezel region BZA. However, this is illustrative, and the bezel region BZA may be disposed adjacent to only one side of the transmissive region TA, or may be omitted.

The display device DD may sense an external input applied from the outside. The external input may include various types of inputs provided from outside the display device DD. For example, the external input may include not only contact by a part of the user's body (e.g., a hand US_F of the user) or contact by a separate device (e.g., an active pen or a digitizer) but also an external input (e.g., hovering) that is applied in proximity to the display device DD or applied adjacent to the display device DD at a certain distance. In addition, the external input may have various forms such as force, pressure, temperature, light, and/or the like.

The display device DD may sense the user's biometric information applied from the outside. A biometric information sensing region capable of sensing the user's biometric information may be provided on the display surface IS of the display device DD. The biometric information sensing region may be provided in the entire area of the transmissive region TA, or may be provided in a partial area of the transmissive region TA. FIG. 1 illustrates an example that the entire transmissive region TA is used as the biometric information sensing region.

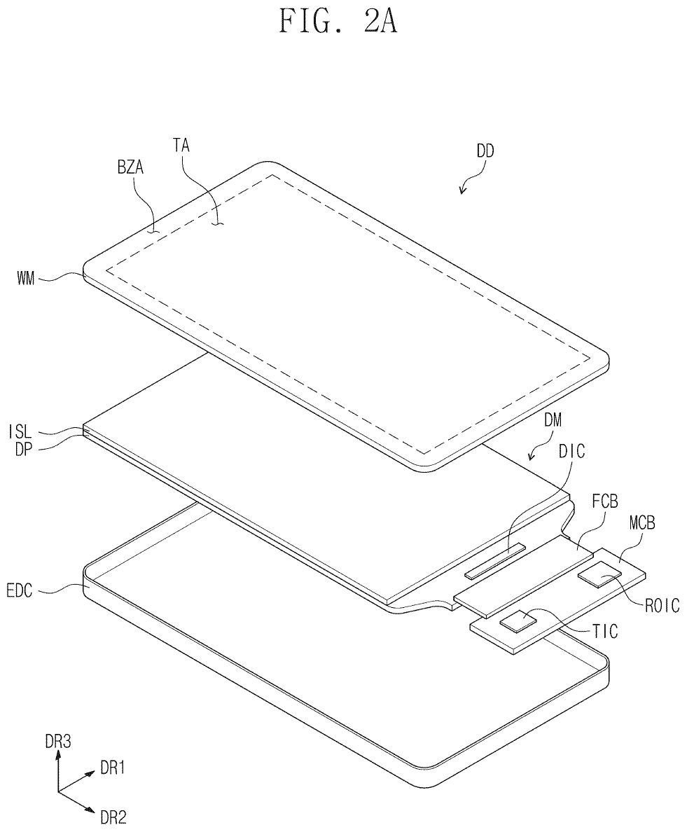

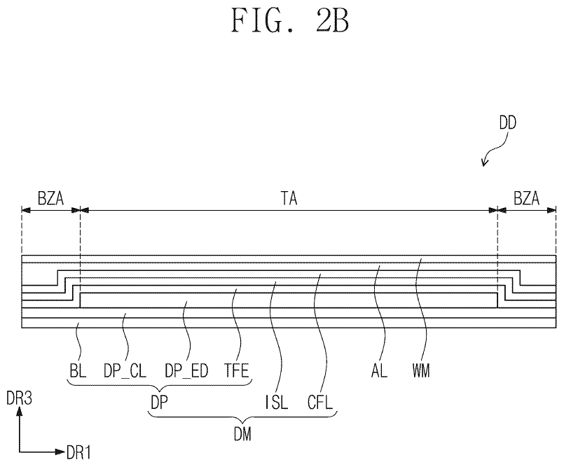

FIG. 2A is an exploded perspective view of the display device according to one or more embodiments of the present disclosure. FIG. 2B is a sectional view of the display device according to one or more embodiments of the present disclosure.

Referring to FIGS. 2A and 2B, the display device DD may include a window WM, a display module DM, and a housing EDC. In this embodiment, the window WM and the housing EDC are coupled with each other to form the exterior of the display device DD.

A front surface of the window WM defines the display surface IS of the display device DD. The window WM may include an optically clear insulating material. For example, the window WM may include glass and/or plastic. The window WM may have a multi-layer structure or a single-layer structure. For example, the window WM may include a plurality of plastic films coupled through an adhesive, or may include a glass substrate and a plastic film coupled through an adhesive.

The display module DM may include a display panel DP and an input sensing layer ISL. The display panel DP may display an image depending on an electrical signal, and the input sensing layer ISL may sense an external input applied from the outside. The external input may be provided in various forms.

The display panel DP according to one or more embodiments of the present disclosure may be an emissive display panel, but is not particularly limited. For example, the display panel DP may be an organic light emitting display panel, an inorganic light emitting display panel, and/or a quantum-dot light emitting display panel. An emissive layer of the organic light emitting display panel may include an organic luminescent material, and an emissive layer of the inorganic light emitting display panel may include an inorganic luminescent material. An emissive layer of the quantum-dot light emitting display panel may include quantum dots and quantum rods. Hereinafter, it will be assumed that the display panel DP is an organic light emitting display panel.

Referring to FIG. 2B, the display panel DP includes a base layer BL, a circuit layer DP_CL, an element layer DP_ED, and an encapsulation layer TFE. The display panel DP according to the present disclosure may be a flexible display panel. However, the present disclosure is not limited thereto. For example, the display panel DP may be a foldable display panel that is folded about a folding axis, or may be a rigid display panel.

The base layer BL may include a synthetic resin layer. The synthetic resin layer may be a polyimide-based resin layer, and the material thereof is not particularly limited. In addition, the base layer BL may include a glass substrate, a metal substrate, or an organic/inorganic composite substrate.

The circuit layer DP_CL is disposed on the base layer BL. The circuit layer DP_CL is disposed between the base layer BL and the element layer DP_ED. The circuit layer DP_CL includes at least one insulating layer and a circuit element. Hereinafter, the insulating layer included in the circuit layer DP_CL is referred to as an intermediate insulating layer. The intermediate insulating layer includes at least one intermediate inorganic film and at least one intermediate organic film. The circuit element may include a pixel drive circuit included in each of a plurality of pixels for displaying an image and a sensor drive circuit included in each of a plurality of sensors for recognizing external information. The external information may be biometric information. In one or more embodiments of the present disclosure, the sensor may be a fingerprint recognition sensor, a proximity sensor, an iris recognition sensor, a blood pressure measurement sensor, an illuminance sensor, and/or the like. Alternatively, the sensor may be an optical sensor for optically recognizing biometric information. The circuit layer DP_CL may further include signal lines connected to the pixel drive circuit and/or the sensor drive circuit.

The element layer DP_ED may include a light emitting element included in each of the pixels and a light receiving element included in each of the sensors. In one or more embodiments of the present disclosure, the light receiving element may be a photo diode. The light receiving element may be a sensor that senses, or reacts to, light reflected by a fingerprint of the user.

The encapsulation layer TFE seals the element layer DP_ED and is disposed over the circuit layer DP_CL and the element layer DP_ED. The encapsulation layer TFE may include at least one organic film and/or at least one inorganic film. The inorganic film may include an inorganic material and may protect the element layer DP_ED from moisture and/or oxygen. The inorganic film may include a silicon nitride layer, a silicon oxy nitride layer, a silicon oxide layer, a titanium oxide layer, and/or an aluminum oxide layer, but is not particularly limited thereto. The organic film may include an organic material and may protect the element layer DP_ED from foreign matter such as dust particles.

The input sensing layer ISL may be formed on the display panel DP. The input sensing layer ISL may be directly disposed on the encapsulation layer TFE. According to one or more embodiments of the present disclosure, the input sensing layer ISL may be formed on the display panel DP by a continuous process. That is, when the input sensing layer ISL is directly disposed on the display panel DP, an adhesive film is not disposed between the input sensing layer ISL and the encapsulation layer TFE. Alternatively, an adhesive film may be disposed between the input sensing layer ISL and the display panel DP. In this case, the input sensing layer ISL may not be manufactured together with the display panel DP by a continuous process and may be manufactured separately from the display panel DP and then fixed to the upper surface of the display panel DP by the adhesive film.

The input sensing layer ISL may sense an external input (e.g., a touch of the user), may change the sensed external input into a certain input signal, and may provide the input signal to the display panel DP. The input sensing layer ISL may include a plurality of sensing electrodes for sensing the external input. The sensing electrodes may sense the external input in a capacitive type. The display panel DP may receive the input signal from the input sensing layer ISL and may generate an image corresponding to the input signal.

The display module DM may further include a color filter layer CFL. In one or more embodiments of the present disclosure, the color filter layer CFL may be disposed on the input sensing layer ISL. However, the present disclosure is not limited thereto. The color filter layer CFL may be disposed between the display panel DP and the input sensing layer ISL. The color filter layer CFL may include a plurality of color filters and a black matrix.

The structures of the input sensing layer ISL and the color filter layer CFL will be described below in detail.

The display device DD according to one or more embodiments of the present disclosure may further include an adhesive layer AL. The window WM may be attached to the input sensing layer ISL and/or the color filter layer CFL by the adhesive layer AL. The adhesive layer AL may include an optically clear adhesive, an optically clear adhesive resin, and/or a pressure sensitive adhesive (PSA).

The display module DM may further include a display driver chip DIC, a flexible circuit film FCB, a main circuit board MCB, a touch driver chip TIC, and a readout chip ROIC. In one or more embodiments of the present disclosure, the display driver chip DIC may be mounted on the display panel DP. The display driver chip DIC may be disposed adjacent to one end portion of the display panel DP.

The flexible circuit film FCB may be coupled to the display panel DP. The flexible circuit film FCB may be coupled to the one end portion of the display panel DP and may be electrically connected to the display driver chip DIC and the display panel DP. The touch driver chip TIC and the readout chip ROIC may be mounted on the main circuit board MCB. The flexible circuit film FCB may be disposed between the main circuit board MCB and the display panel DP. The flexible circuit film FCB may electrically connect the touch driver chip TIC to the input sensing layer ISL and may electrically connect the readout chip ROIC to the display panel DP.

Although FIG. 2A illustrates the structure in which the readout chip ROIC is mounted on the main circuit board MCB, the present disclosure is not limited thereto. For example, the readout chip ROIC may be disposed on the one end portion of the display panel DP so as to be adjacent to the display driver chip DIC. In addition, although FIG. 2A illustrates the structure in which the touch driver chip TIC and the readout chip ROIC are provided as independent components, the present disclosure is not limited thereto. For example, the touch driver chip TIC and the readout chip ROIC may be integrated into one chip.

The housing EDC is combined with the window WM. The housing EDC is coupled with the window WM to provide a certain inner space. The display module DM may be accommodated in the inner space. The housing EDC may include a material having a relatively high rigidity. For example, the housing EDC may include glass, plastic, and/or metal, or may include a plurality of frames and/or plates formed of a combination thereof. The housing EDC may stably protect components of the display device DD accommodated in the inner space from external impact. In one or more embodiments, a battery module for supplying power required for overall operation of the display device DD may be disposed between the display module DM and the housing EDC.

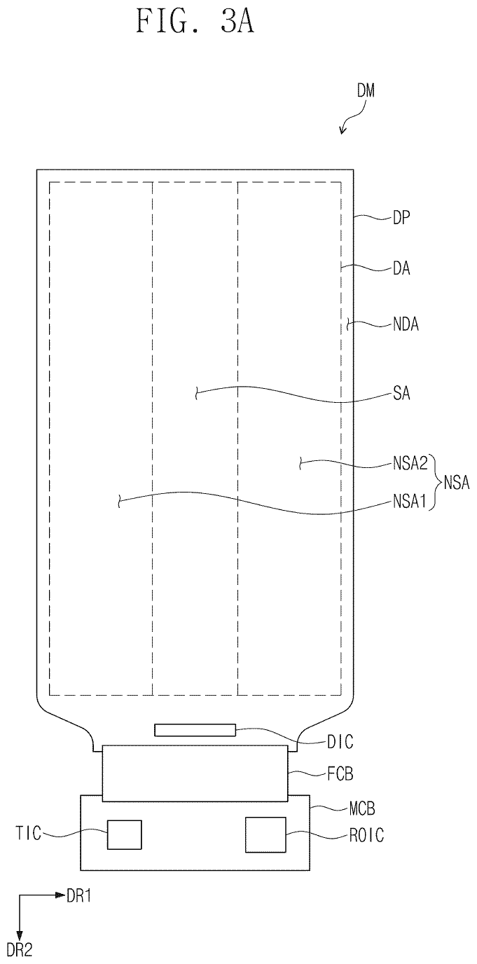

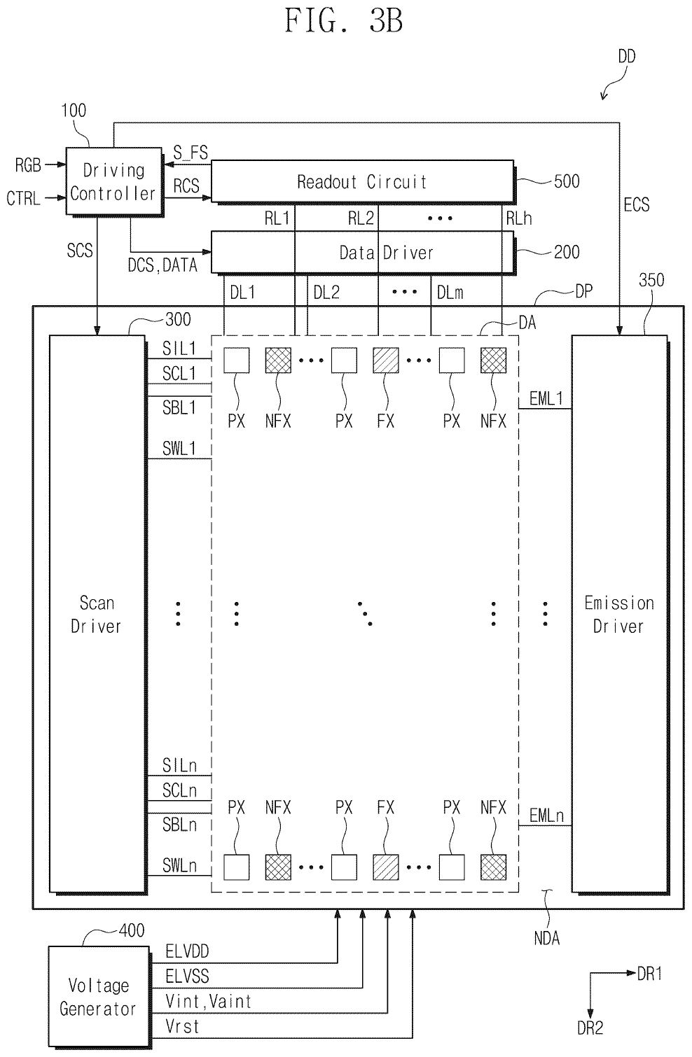

FIG. 3A is a plan view of the display module according to one or more embodiments of the present disclosure, and FIG. 3B is a block diagram of the display device according to one or more embodiments of the present disclosure.

Referring to FIGS. 3A and 3B, the display panel DP includes a display region DA and a non-display region NDA around an edge or a periphery of the display region DA. The display region DA is a region that substantially displays an image, and the non-display region NDA is a region on which no image is displayed. The display region DA may correspond to the transmissive region TA (illustrated in FIG. 1) of the display device DD, and the non-display region NDA may correspond to the bezel region BZA (illustrated in FIG. 1) of the display device DD. In one or more embodiments of the present disclosure, the non-display region NDA is formed to surround the display region DA.

The display region DA may include a sensing region SA (or, a first region) and a non-sensing region NSA (or, a second region). The sensing region SA may be a region that is able to substantially recognize biometric information, and the non-sensing region NSA may be a region that is not able to substantially recognize biometric information. In one or more embodiments of the present disclosure, the non-sensing region NSA includes a first non-sensing region NSA1 disposed on a first side of the sensing region SA and a second non-sensing region NSA2 disposed on a second side of the sensing region SA. That is, the sensing region SA may be disposed between the first and second non-sensing regions NSA1 and NSA2. Although FIG. 3A illustrates the structure in which the non-sensing region NSA includes the two non-sensing regions NSA1 and NSA1, the present disclosure is not limited thereto. For example, the non-sensing region NSA may be provided on only one side of the sensing region SA, or may be provided to be around (e.g., to surround) the sensing region SA.

The display panel DP includes a plurality of pixels PX, a plurality of effective sensors FX (or, first sensors), and a plurality of ineffective sensors NFX (or, second sensors). The plurality of pixels PX are entirely disposed in the display region DA. The plurality of effective sensors FX are disposed in the sensing region SA of the display region DA, and the plurality of ineffective sensors NFX are disposed in the non-sensing region NSA of the display region DA. The plurality of effective sensors FX are disposed adjacent to the pixels PX in the sensing region SA, and the plurality of ineffective sensors NFX are disposed adjacent to the pixels PX in the non-sensing region NSA.

The readout chip ROIC may be electrically connected with the effective sensors FX disposed in the sensing region SA and may receive a detection signal obtained by sensing biometric information. The readout chip ROIC may not be electrically connected with the ineffective sensors NFX disposed in the non-sensing region NSA.

Referring to FIG. 3B, the display device DD includes the display panel DP, a panel driver, and a driving controller 100. In one or more embodiments of the present disclosure, the panel driver includes a data driver 200, a scan driver 300, an emission driver 350, a voltage generator 400, and a readout circuit 500.

The driving controller 100 receives an image signal RGB and a control signal CTRL. The driving controller 100 generates image data DATA by converting the data format of the image signal RGB according to the specification of an interface with the data driver 200. The driving controller 100 outputs a first control signal SCS, a second control signal ECS, a third control signal DCS, and a fourth control signal RCS.

The data driver 200 receives the third control signal DCS and the image data DATA from the driving controller 100. The data driver 200 converts the image data DATA into data signals and outputs the data signals to a plurality of data lines DL1 to DLm that will be described below. The data signals are analog voltages corresponding to gray level values of the image data DATA. In one or more embodiments of the present disclosure, the data driver 200 may be embedded in the driver IC DIC illustrated in FIG. 2A.

The scan driver 300 receives the first control signal SCS from the driving controller 100. The scan driver 300 may output scan signals to scan lines in response to the first control signal SCS.

The voltage generator 400 generates voltages required for operation of the display panel DP. In this embodiment, the voltage generator 400 generates a first drive voltage ELVDD, a second drive voltage ELVSS, a first initialization voltage Vint, a second initialization voltage Vaint, and a reset voltage Vrst.

The display panel DP further includes initialization scan lines SIL1 to SILn, compensation scan lines SCL1 to SCLn, write scan lines SWL1 to SWLn, black scan lines SBL1 to SBLn, emission control lines EML1 to EMLn, the data lines DL1 to DLm, and readout lines RL1 to RLh. The initialization scan lines SIL1 to SILn, the compensation scan lines SCL1 to SCLn, the write scan lines SWL1 to SWLn, the black scan lines SBL1 to SBLn, and the emission control lines EML1 to EMLn extend in the first direction DR1. The initialization scan lines SIL1 to SILn, the compensation scan lines SCL1 to SCLn, the write scan lines SWL1 to SWLn, the black scan lines SBL1 to SBLn, and the emission control lines EML1 to EMLn are arranged along the second direction DR2 so as to be spaced (e.g., spaced apart) from one another. The data lines DL1 to DLm and the readout lines RL1 to RLh extend in the second direction DR2 and are arranged along the first direction DR1 so as to be spaced (e.g., spaced apart) from one another. Here, “n”, “m”, and “h” are natural numbers of or more.

The plurality of pixels PX are electrically connected to the initialization scan lines SIL1 to SILn, the compensation scan lines SCL1 to SCLn, the write scan lines SWL1 to SWLn, the black scan lines SBL1 to SBLn, the emission control lines EML1 to EMLn, and the data lines DL1 to DLm, respectively. For example, each of the plurality of pixels PX may be electrically connected to four scan lines. However, without being limited thereto, the number of scan lines connected to each pixel PX may be changed.

Each of the plurality of effective sensors FX is electrically connected to a corresponding write scan line from among the write scan lines SWL1 to SWLn and a corresponding readout line from among the readout lines RL1 to RLh. Each of the plurality of ineffective sensors NFX is electrically connected to a corresponding write scan line from among the write scan lines SWL1 to SWLn and a corresponding readout line from among the readout lines RL1 to RLh. Each of the plurality of effective sensors FX and each of the plurality of ineffective sensors NFX may be electrically connected to one scan line. However, the present disclosure is not limited thereto. The number of scan lines connected to each effective sensor FX and each ineffective sensor NFX may be varied.

In one or more embodiments of the present disclosure, the number of readout lines RL1 to RLh may be smaller than or equal to the number of data lines DL1 to DLm. For example, the number of readout lines RL1 to RLh may correspond to ½, ¼, or ⅛ of the number of data lines DL1 to DLm. Readout lines disposed in the sensing region SA and connected to the effective sensors FX from among the readout lines RL1 to RLh are referred to as effective readout lines. In addition, readout lines disposed in the non-sensing region NSA and connected to the ineffective sensors NFX from among the readout lines RL1 to RLh are referred to as ineffective readout lines. The number of effective readout lines may be smaller than the number of readout lines RL1 to RLh.

The scan driver 300 may be disposed in the non-display region NDA of the display panel DP. The scan driver 300 receives the first control signal SCS from the driving controller 100. In response to the first control signal SCS, the scan driver 300 outputs initialization scan signals to the initialization scan lines SIL1 to SILn and outputs compensation scan signals to the compensation scan lines SCL1 to SCLn. Furthermore, in response to the first control signal SCS, the scan driver 300 may output write scan signals to the write scan lines SWL1 to SWLn and may output black scan signals to the black scan lines SBL1 to SBLn. Alternatively, the scan driver 300 may include first and second scan drivers. The first scan driver may output the initialization scan signals and the compensation scan signals, and the second scan driver may output the write scan signals and the black scan signals.

The emission driver 350 may be disposed in the non-display region NDA of the display panel DP. The emission driver 350 receives the second control signal ECS from the driving controller 100. In response to the second control signal ECS, the emission driver 350 may output emission control signals to the emission control lines EML1 to EMLn. Alternatively, the scan driver 300 may be connected to the emission control lines EML1 to EMLn. In this case, the emission driver 350 may be omitted, and the scan driver 300 may output the emission control signals to the emission control lines EML1 to EMLn.

The readout circuit 500 receives the fourth control signal RCS from the driving controller 100. In response to the fourth control signal RCS, the readout circuit 500 may receive detection signals (or, effective detection signals) from the effective readout lines from among the readout lines RL1 to RLh. The readout circuit 500 may process the detection signals received from the effective readout lines and may provide processed detection signals S_FS to the driving controller 100. The driving controller 100 may recognize biometric information based on the processed detection signals S_FS. In one or more embodiments of the present disclosure, the readout circuit 500 may be embedded in the readout chip ROIC illustrated in FIG. 3A.

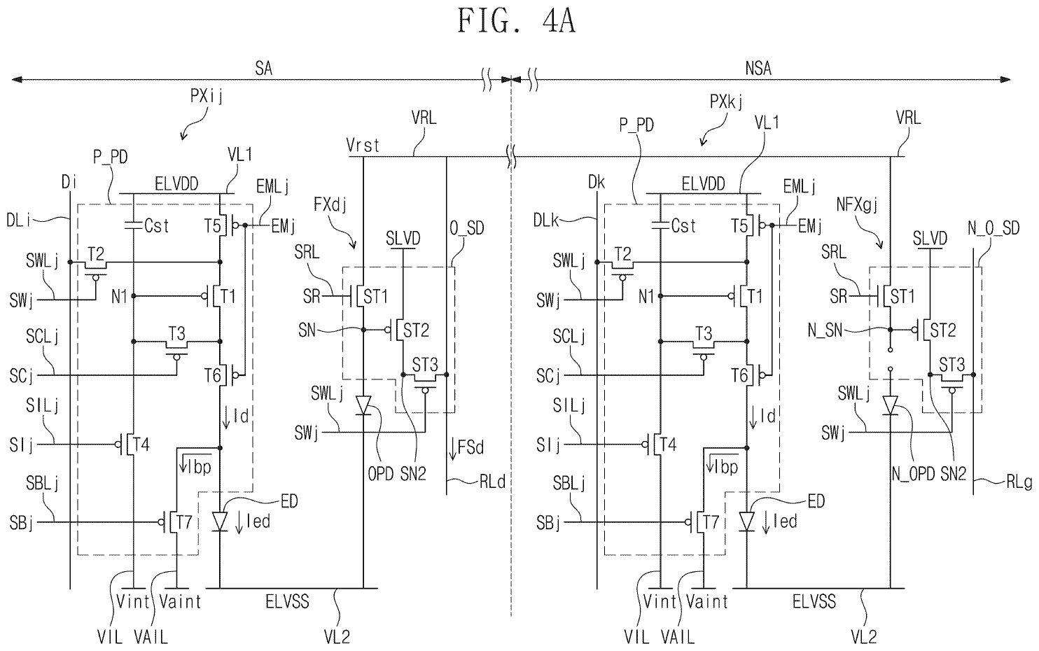

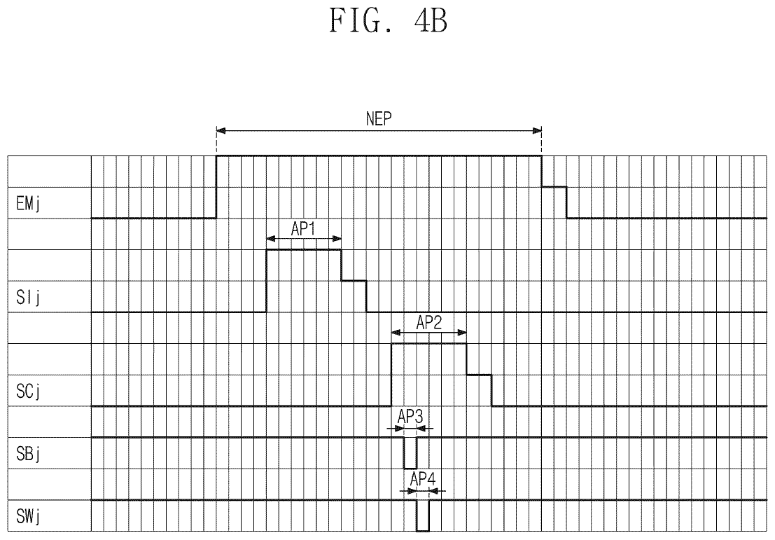

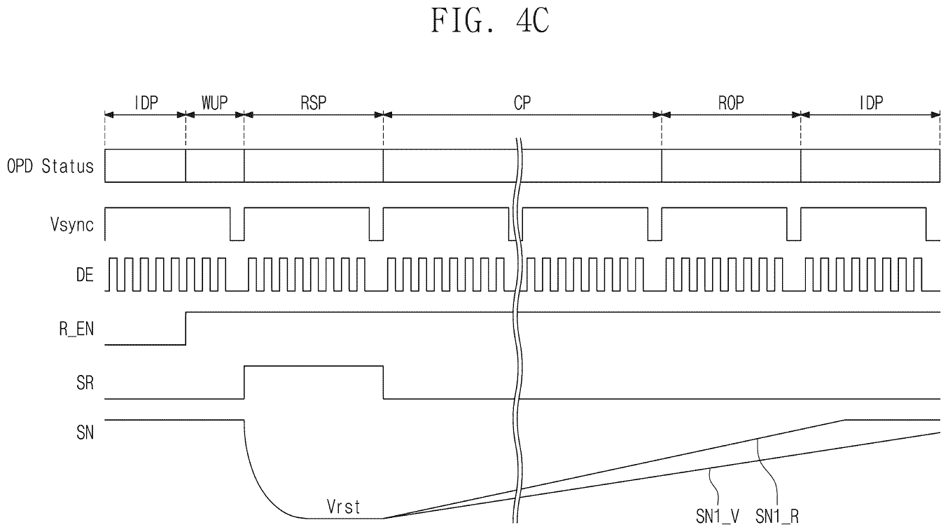

FIG. 4A is a circuit diagram illustrating a pixel and an effective sensor disposed in the sensing region and a pixel and an ineffective sensor disposed in the non-sensing region according to one or more embodiments of the present disclosure. FIG. 4B is a waveform diagram for explaining operation of the pixel illustrated in FIG. 4A, and FIG. 4C is a waveform diagram for explaining operation of the effective sensor illustrated in FIG. 4A.

In FIG. 4A, an equivalent circuit diagram of first and second pixels PXij and PXkj from among the plurality of pixels PX illustrated in FIG. 3B is illustrated. Because the plurality of pixels PX have the same circuit structure, description of the circuit structures for the first and second pixels PXij and PXkj may be applied to the remaining pixels, and detailed description of the remaining pixels will be omitted. Furthermore, in FIG. 4A, an equivalent circuit diagram of one effective sensor FXdj from among the plurality of effective sensors FX illustrated in FIG. 3B is illustrated. Because the plurality of effective sensors FX have the same circuit structure, description of the circuit structure for the effective sensor FXdj may be applied to the remaining effective sensors, and detailed description of the remaining effective sensors will be omitted. In FIG. 4A, an equivalent circuit diagram of one ineffective sensor NFXgj from among the plurality of ineffective sensors NFX illustrated in FIG. 3B is illustrated. Because the plurality of ineffective sensors NFX have the same circuit structure, description of the circuit structure for the ineffective sensor NFXgj may be applied to the remaining ineffective sensors, and detailed description of the remaining ineffective sensors will be omitted.

Referring to FIG. 4A, the first pixel PXij is connected to the i-th data line DLi from among the data lines DL1 to DLm, the j-th initialization scan line SILj from among the initialization scan lines SIL1 to SILn, the j-th compensation scan line SCLj from among the compensation scan lines SCL1 to SCLn, the j-th write scan line SWLj from among the write scan lines SWL1 to SWLn, the j-th black scan line SBLj from among the black scan lines SBL1 to SBLn, and the j-th emission control line EMLj from among the emission control lines EML1 to EMLn. The second pixel PXkj is connected to the k-th data line DLk from among the data lines DL1 to DLm, the j-th initialization scan line SILj, the j-th compensation scan line SCLj, the j-th write scan line SWLj, the j-th black scan line SBLj, and the j-th emission control line EMLj. That is, the first pixel PXij has the same structure as the second pixel PXkj, differing only in terms of the connected data lines. Accordingly, description of the second pixel PXkj is replaced with description of the first pixel PXij.

The first pixel PXij includes a light emitting element ED and a pixel drive circuit P_PD. The light emitting element ED may be a light emitting diode. In one or more embodiments of the present disclosure, the light emitting element ED may be an organic light emitting diode including an organic light emitting layer.

The pixel drive circuit P_PD includes first to seventh transistors T1, T2, T3, T4, T5, T6, and T7 and one capacitor Cst. At least one of the first to seventh transistors T1 to T7 may be a transistor having a low-temperature polycrystalline silicon (LTPS) semiconductor layer. Some of the first to seventh transistors T1 to T7 may be P-type transistors, and the others may be N-type transistors. At least one of the first to seventh transistors T1 to T7 may be a transistor having an oxide semiconductor layer. For example, the third and fourth transistors T3 and T4 may be oxide semiconductor transistors, and the first, second, and fifth to seventh transistors T1, T2, and T5 to T7 may be LTPS transistors. The third and fourth transistors T3 and T4 may be NMOS transistors.

The configuration of the pixel drive circuit P_PD according to the present disclosure is not limited to the embodiment illustrated in FIG. 4A. The pixel drive circuit P_PD illustrated in FIG. 4A is merely an example, and various changes and modifications may be made to the configuration of the pixel drive circuit P_PD. For example, the first, second, and fifth to seventh transistors T1, T2, and T5 to T7 may all be P-type transistors or N-type transistors. In addition, the pixel drive circuit P_PD may further include one transistor in addition to the seven transistors.

The j-th initialization scan line SILj, the j-th compensation scan line SCLj, the j-th write scan line SWLj, the j-th black scan line SBLj, and the j-th emission control line EMLj may transfer the j-th initialization scan signal SIj, the j-th compensation scan signal SCj, the j-th write scan signal SWj, the j-th black scan signal SBj, and the j-th emission control signal EMj to the first and second pixels PXij 25 and PXkj. The i-th data line DLi transfers the i-th data signal Di to the first pixel PXij, and the k-th data line DLk transfers the k-th data signal Dk to the second pixel PXkj. Each of the i-th data signal Di and the k-th data signal Dk may have a voltage level corresponding to the image signal RGB (e.g., refer to FIG. 3A) that is input to the display device DD (e.g., refer to FIG. 3B).

In one or more embodiments of the present disclosure, each of the first and second pixels PXij and PXkj may be connected to first and second drive voltage lines VL1 and VL2 and first and second initialization voltage lines VIL and VAIL. The first drive voltage line VL1 may transfer the first drive voltage ELVDD to the first and second pixels PXij and PXkj, and the second drive voltage line VL2 may transfer the second drive voltage ELVSS to the first and second pixels PXij and PXkj. In addition, the first initialization voltage line VIL may transfer the first initialization voltage Vint to the first and second pixels PXij and PXkj, and the second initialization voltage line VAIL may transfer the second initialization voltage Vaint to the first and second pixels PXij and PXkj.

The first transistor T1 is connected between the first drive voltage line VL1, which receives the first drive voltage ELVDD, and the light emitting element ED. The first transistor T1 includes a first electrode connected with the first drive voltage line VL1 via the fifth transistor T5, a second electrode connected with an anode electrode of the light emitting element ED via the sixth transistor T6, and a third electrode (e.g., a gate electrode) connected with one end of the capacitor Cst (e.g., a first node N1). The first transistor T1 may receive the i-th data signal Di (or, the k-th data signal Dk) that the i-th data line DLi (or the k-th data line DLk) transfers depending on a switching operation of the second transistor T2 and may supply a drive current Id to the light emitting element ED.

The second transistor T2 is connected between the i-th data line DLi (or the k-th data line DLk) and the first electrode of the first transistor T1. The second transistor T2 includes a first electrode connected with the i-th data line DLi (or the k-th data line DLk), a second electrode connected with the first electrode of the first transistor T1, and a third electrode (e.g., a gate electrode) connected with the j-th write scan line SWLj. The second transistor T2 may be turned on depending on the j-th write scan signal SWj transferred through the j-th write scan line SWLj and may transfer, to the first electrode of the first transistor T1, the i-th data signal Di transferred from the i-th data line DLi.

The third transistor T3 is connected between the second electrode of the first transistor T1 and the first node N1. The third transistor T3 includes a first electrode connected with the third electrode (e.g., the gate electrode) of the first transistor T1, a second electrode connected with the second electrode of the first transistor T1, and a third electrode (e.g., a gate electrode) connected with the j-th compensation scan line SCLj. The third transistor T3 may be turned on depending on the j-th compensation scan signal SCj transferred through the j-th compensation scan line SCLj and may diode-connect the first transistor T1 by connecting the third electrode (e.g., the gate electrode) and the second electrode of the first transistor T1.

The fourth transistor T4 is connected between the first initialization voltage line VIL to which the first initialization voltage Vint is applied and the first node N1. The fourth transistor T4 includes a first electrode connected with the first initialization voltage line VIL to which the first initialization voltage Vint is transferred, a second electrode connected with the first node N1, and a third electrode (e.g., a gate electrode) connected with the j-th initialization scan line SILj. The fourth transistor T4 is turned on depending on the j-th initialization scan signal SIj transferred through the j-th initialization scan line SILj. The turned-on fourth transistor T4 initializes the potential of the third electrode (e.g., the gate electrode) of the first transistor T1 (that is, the potential of the first node N1) by transferring the first initialization voltage Vint to the first node N1.

The fifth transistor T5 includes a first electrode connected with the first 25 drive voltage line VL1, a second electrode connected with the first electrode of the first transistor T1, and a third electrode (e.g., a gate electrode) connected to the j-th emission control line EMLj.

The sixth transistor T6 includes a first electrode connected with the second electrode of the first transistor T1, a second electrode connected to the anode electrode of the light emitting element ED, and a third electrode (e.g., a gate electrode) connected to the j-th emission control line EMLj.

The fifth and sixth transistors T5 and T6 are concurrently (e.g., simultaneously) turned on depending on the j-th emission control signal EMj transferred through the j-th emission control line EMLj. The first drive voltage ELVDD applied through the turned-on fifth transistor T5 may be compensated for through the diode-connected first transistor T1 and thereafter may be transferred to the light emitting element ED.

The seventh transistor T7 includes a first electrode connected to the second initialization voltage line VAIL to which the second initialization voltage Vaint is transferred, a second electrode connected with the second electrode of the sixth transistor T6, and a third electrode (e.g., a gate electrode) connected with the j-th black scan line SBLj. The second initialization voltage Vaint may have a voltage level lower than or equal to the voltage level of the first initialization voltage Vint.

The seventh transistor T7 is turned on depending on the j-th black scan signal SBj transferred through the j-th black scan line SBLj. The second initialization voltage Vaint applied through the turned-on seventh transistor T7 may be transferred to the anode electrode of the light emitting element ED. Accordingly, the anode electrode of the light emitting element ED may be initialized to the second initialization voltage Vaint.

Alternatively, the first pixel PXij may further include an eighth transistor that receives a bias voltage. The eighth transistor includes a first electrode connected to a bias voltage line to which the bias voltage is transferred, a second electrode connected with the first electrode of the first transistor T1, and a third electrode (e.g., a gate electrode) connected with the j-th black scan line SBLj. In this case, the eighth transistor may be turned on depending on the j-th black scan signal SBj, and the bias voltage may be transferred to the first electrode of the first transistor T1. Accordingly, the bias voltage may be periodically applied to the first electrode of the first transistor T1. As a result, deterioration in display quality due to an increase in the potential difference between the first and second electrodes of the first transistor T1 to a certain level or higher by a magnetic hysteresis phenomenon may be prevented or reduced.

The one end of the capacitor Cst is connected with the third electrode of the first transistor T1 (e.g., the first node N1) as described above, and the opposite end of the capacitor Cst is connected with the first drive voltage line VL1. A cathode electrode of the light emitting element ED may be connected with the second drive voltage line VL2 that transfers the second drive voltage ELVSS. The second drive voltage ELVSS may have a lower voltage level than the first drive voltage ELVDD. In one or more embodiments of the present disclosure, the second drive voltage ELVSS may have a lower voltage level than the first and second initialization voltages Vint and Vaint.

Referring to FIGS. 4A and 4B, the j-th emission control signal EMj has a high level during a non-light emission period NEP. Within the non-light emission period NEP, the j-th initialization scan signal SIj is activated. When the j-th initialization scan signal SIj having a high level is provided through the j-th initialization scan line SILj during an activation period AP1 of the j-th initialization scan signal SIj (hereinafter, referred to as the first activation period), the fourth transistor T4 is turned on in response to the j-th initialization scan signal SIj having the high level. The first initialization voltage Vint is transferred to the third electrode (e.g., the gate electrode) of the first transistor T1 through the turned-on fourth transistor T4, and the first node N1 is initialized to the first initialization voltage Vint. Accordingly, the first activation period AP1 may be defined as an initialization period of the first pixel PXij.

Next, when the j-th compensation scan signal SCj is activated and the j-th compensation scan signal SCj having a high level is supplied through the j-th compensation scan line SCLj during an activation period AP2 of the j-th compensation scan signal SCj (hereinafter, referred to as the second activation period), the third transistor T3 is turned on. The first transistor T1 is diode-connected by the turned-on third transistor T3 and forward-biased. The first activation period AP1 may not overlap the second activation period AP2.

Within the second activation period AP2, the j-th write scan signal SWj is activated. The j-th write scan signal SWj has a low level during an activation period AP4 (hereinafter, referred to as the fourth activation period). During the fourth activation period AP4, the second transistor T2 is turned on by the j-th write scan signal SWj having the low level. Then, a compensation voltage “Di-Vth” obtained by subtracting the threshold voltage Vth of the first transistor T1 from the i-th data signal Di supplied from the i-th data line DLi is applied to the third electrode (e.g., the gate electrode) of the first transistor T1. That is, the potential of the third electrode (e.g., the gate electrode) of the first transistor T1 may be the compensation voltage “Di-Vth”. The fourth activation period AP4 may overlap the second activation period AP2. The duration time of the second activation period AP2 may be greater than the duration time of the fourth activation period AP4.

The first drive voltage ELVDD and the compensation voltage “Di-Vth” may be applied to the opposite ends of the capacitor Cst, and charges corresponding to a difference between voltages at the opposite ends of the capacitor Cst may be stored in the capacitor Cst. Here, the period during which the j-th compensation scan signal SCj has the high level may be referred to as a compensation period of the first pixel PXij.

In one or more embodiments, the j-th black scan signal SBj is activated within the second activation period AP2 of the j-th compensation scan signal SCj. The j-th black scan signal SBj has a low level during an activation period AP3 (hereinafter, referred to as the third activation period). During the third activation period AP3, the seventh transistor T7 is turned on by receiving the j-th black scan signal SBj having the low level through the j-th black scan line SBLj. A portion of the drive current Id may escape through the seventh transistor T7 as a bypass current Ibp. The third activation period AP3 may overlap the second activation period AP2. The duration time of the second activation period AP2 may be greater than the duration time of the third activation period AP3. The third activation period AP3 may precede the fourth activation period AP4 and may not overlap the fourth activation period AP4.

When the first pixel PXij displays a black image, the first pixel PXij is not able to normally display the black image if the light emitting element ED emits light even though the minimum drive current of the first transistor T1 flows as the drive current Id. Accordingly, the seventh transistor T7 in the first pixel PXij according to one or more embodiments of the present disclosure may distribute a portion of the minimum drive current of the first transistor T1 as the bypass current Ibp to a current path other than the current path toward the light emitting element ED. Here, the minimum drive current of the first transistor T1 means a current flowing to the first transistor T1 under the condition that a gate-source voltage Vgs of the first transistor T1 is lower than the threshold voltage Vth so that the first transistor T1 is turned off. The minimum drive current (e.g., a current of 10 pA or less) flowing to the first transistor T1 under the condition that the first transistor T1 is turned off is transferred to the light emitting element ED, and a black gray-scale image is displayed. When the first pixel PXij displays the black image, an influence of the bypass current Ibp on the minimum drive current is relatively great, whereas when the first pixel PXij displays an image such as a general image or a white image, the bypass current Ibp has little influence on the drive current Id. Accordingly, when the first pixel PXij displays the black image, the current obtained by subtracting the bypass current Ibp escaping through the seventh transistor T7 from the drive current Id (that is, a light emission current led) may be provided to the light emitting element ED so that the first pixel PXij clearly expresses the black image. Thus, the first pixel PXij may implement an accurate black gray-scale image using the seventh transistor T7, thereby improving the contrast ratio.

After that, the j-th emission control signal EMj supplied from the j-th emission control line EMLj is changed from the high level to a low level. The fifth and sixth transistors T5 and T6 are turned on by the emission control signal EMj having the low level. Then, the drive current Id depending on the difference between the voltage of the third electrode of the first transistor T1 and the first drive voltage ELVDD is generated. The drive current Id is supplied to the light emitting element ED through the sixth transistor T6, and the light emission current led flows through the light emitting element ED.

Referring again to FIG. 4A, the effective sensor FXdj is connected to the d-th readout line RLd (or, referred to as an effective readout line) from among the readout lines RL1 to RLh, the j-th write scan line SWLj, and a reset control line SRL.

The effective sensor FXdj includes a light receiving element OPD (referred to as an effective light receiving element or a first light receiving element) and a sensor drive circuit O_SD (referred to as an effective sensor drive circuit or a first sensor drive circuit). In one or more embodiments of the present disclosure, the effective light receiving element OPD may be an organic photo diode including an organic material as a photoelectric conversion layer. Although FIG. 4A illustrates the structure in which the effective sensor FXdj includes one effective light receiving element, the present disclosure is not limited thereto. For example, the effective sensor FXdj may include a plurality of effective light receiving elements OPD connected in parallel. In one or more embodiments, the effective sensor FXdj may include a plurality of effective light receiving elements OPD connected in a series/parallel connection.

An anode electrode of the light receiving element OPD may be connected to an effective sensing node SN, and a cathode electrode of the light receiving element OPD may be connected with the second drive voltage line VL2 that transfers the second drive voltage ELVSS. The cathode electrode of the effective light receiving element OPD may be electrically connected with the cathode electrode of the light emitting element ED. In one or more embodiments of the present disclosure, the cathode electrode of the effective light receiving element OPD may be integrally formed with the cathode electrode of the light emitting element ED to form a common cathode electrode.

The effective sensor drive circuit O_SD includes three transistors ST1, ST2, and ST3. The three transistors ST1, ST2, and ST3 may be a reset transistor ST1, an amplifying transistor ST2, and an output transistor ST3. At least one of the reset transistor ST1, the amplifying transistor ST2, or the output transistor ST3 may be an oxide semiconductor transistor. In one or more embodiments of the present disclosure, the reset transistor ST1 may be an oxide semiconductor transistor, and the amplifying transistor ST2 and the output transistor ST3 may be LTPS transistors. However, without being limited thereto, at least the reset transistor ST1 and the output transistor ST3 may be oxide semiconductor transistors, and the amplifying transistor ST2 may be an LTPS transistor.

Furthermore, some of the reset transistor ST1, the amplifying transistor ST2, and the output transistor ST3 may be P-type transistors, and the rest may be an N-type transistor. In one or more embodiments of the present disclosure, the amplifying transistor ST2 and the output transistor ST3 may be PMOS transistors, and the reset transistor ST1 may be an NMOS transistor. However, without being limited thereto, the reset transistor ST1, the amplifying transistor ST2, and the output transistor ST3 may all be N-type transistors or P-type transistors.

At least one (or a part) of the reset transistor ST1, the amplifying transistor ST2, or the output transistor ST3 (e.g., the reset transistor ST1) may be of the same type as the third and fourth transistors T3 and T4 of the first pixel PXij. The amplifying transistor ST2 and the output transistor ST3 may be transistors of the same type as the first, second, and fifth to seventh transistors T1, T2, and T5 to T7 of the first pixel PXij.

The circuit configuration of the effective sensor drive circuit O_SD according to the present disclosure is not limited to that illustrated in FIG. 4A. The effective sensor drive circuit O_SD illustrated in FIG. 4A is merely illustrative, and various changes and modifications may be made to the configuration of the effective sensor drive circuit O_SD.

The reset transistor ST1 includes a first electrode that receives the reset voltage Vrst, a second electrode connected with the effective sensing node SN, and a third electrode that receives a reset control signal SR. The reset transistor ST1 may reset the potential of the effective sensing node SN to the reset voltage Vrst in response to the reset control signal SR. The reset control signal SR may be a signal provided through a reset control line SRL. However, the present disclosure is not limited thereto. Alternatively, the reset control signal SR may be the j-th compensation scan signal SCj supplied through the j-th compensation scan line SCLj. That is, the reset transistor ST1 may receive the j-th compensation scan signal SCj, which is supplied from the j-th compensation scan line SCLj, as the reset control signal SR. In one or more embodiments of the present disclosure, the reset voltage Vrst may have a lower voltage level than the second drive voltage ELVSS at least during an activation period of the reset control signal SR. The reset voltage Vrst may be transferred to the effective sensor FXdj through a reset voltage line VRL. The reset voltage Vrst may be a DC voltage maintained at a voltage level lower than that of the second drive voltage ELVSS.

The reset transistor ST1 may include a plurality of sub-reset transistors connected in series. For example, the reset transistor ST1 may include two sub-reset transistors (hereinafter, referred to as the first and second sub-reset transistors). In this case, a third electrode of the first sub-reset transistor and a third electrode of the second sub-reset transistor are connected to the reset control line SRL. Furthermore, a second electrode of the first sub-reset transistor and a first electrode of the second sub-reset transistor may be electrically connected with each other. In addition, the reset voltage Vrst may be applied to a first electrode of the first sub-reset transistor, and a second electrode of the second sub-reset transistor may be electrically connected with the effective sensing node SN. However, the number of sub-reset transistors is not limited thereto and may be modified in various ways.

The amplifying transistor ST2 includes a first electrode that receives a sensing drive voltage SLVD, a second electrode connected with the output transistor ST3 via a second sensing node SN2, and a third electrode connected with the effective sensing node SN. The amplifying transistor ST2 may be turned on depending on the potential of the effective sensing node SN and may output the sensing drive voltage SLVD. In one or more embodiments of the present disclosure, the sensing drive voltage SLVD may be one of the first drive voltage ELVDD, the first initialization voltage Vint, and the second initialization voltage Vaint. When the sensing drive voltage SLVD is the first drive voltage ELVDD, the first electrode of the amplifying transistor ST2 may be electrically connected to the first drive voltage line VL1. When the sensing drive voltage SLVD is the first initialization voltage Vint, the first electrode of the amplifying transistor ST2 may be electrically connected to the first initialization voltage line VIL, and when the sensing drive voltage SLVD is the second initialization voltage Vaint, the first electrode of the amplifying transistor ST2 may be electrically connected to the second initialization voltage line VAIL.

The output transistor ST3 includes a first electrode connected with the second sensing node SN2, a second electrode connected with the d-th readout line RLd, and a third electrode that receives an output control signal. In response to the output control signal, the output transistor ST3 may transfer a detection signal FSd to the d-th readout line RLd. The output control signal may be the j-th write scan signal SWj supplied through the j-th write scan line SWLj. That is, the output transistor ST3 may receive the j-th write scan signal SWj, which is supplied from the j-th write scan line SWLj, as the output control signal.

The effective light receiving element OPD of the effective sensor FXdj may be exposed to light during a light emission period of the light emitting element ED. The light may be light output from the light emitting element ED.

Referring to FIGS. 4A and 4C, when the user executes a specific application, the display device DD may display an image for user authentication if the corresponding application is an application that has to identify the user's authentication information. The effective sensor FXdj may remain in an idle state until the user actually provides an input. The period during which the effective sensor FXdj is in the idle state may be referred to as an idle period IDP.

Thereafter, when the user attempts an input, an enable signal R_EN may be activated. The readout chip ROIC (refer to FIG. 3A) may generate the reset control signal SR based on (e.g., using) the enable signal R_EN, a vertical synchronization signal Vsync, and other control signals (e.g., a data enable signal DE). In one or more embodiments of the present disclosure, the readout chip ROIC may activate the reset control signal SR at the first rising time of the vertical synchronization signal Vsync after the enable signal R_EN is activated and may deactivate the reset control signal SR at the second rising time of the vertical synchronization signal Vsync. Here, the activation period of the reset control signal SR may be referred to as a reset period RSP. The period between the activation time of the enable signal R_EN and the activation time of the reset control signal SR may be referred to as a wake-up period WUP.

When the reset period RSP starts, the reset transistor ST1 of the effective sensor FXdj may be turned on in response to the reset control signal SR, and the potential of the effective sensing node SN may be lowered to the reset voltage Vrst by the reset voltage Vrst provided through the turned-on reset transistor ST1.

When the reset period RSP ends, the effective sensor FXdj may receive light to collect information provided by the user during a certain period (e.g., a collection period CP). Here, the effective light receiving element OPD of the effective sensor FXdj generates photocharges corresponding to light reflected by ridges of a fingerprint or valleys between the ridges. The amount of current flowing through the effective light receiving element OPD varies depending on the generated photocharges. When the effective light receiving element OPD receives light reflected by the ridges of the fingerprint, a current flowing through the effective light receiving element OPD may be referred to as a first current, and when the effective light receiving element OPD receives light reflected by the valleys of the fingerprint, a current flowing through the effective light receiving element OPD may be referred to as a second current. The amount of light reflected by the ridges of the fingerprint and the amount of light reflected by the valleys of the fingerprint differ from each other, and the difference between the amounts of light appears as a difference between the first and second currents. When the first current flows through the effective light receiving element OPD, the potential of the effective sensing node SN may be referred to as a first potential SN1_R, and when the second current flows through the effective light receiving element OPD, the potential of the effective sensing node SN may be referred to as a second potential SN1_V. In one or more embodiments of the present disclosure, the first current may be greater than the second current. In this case, the second potential SN1_V may be lower than the first potential SN1_R.

The amplifying transistor ST2 may be a source follower amplifier that generates a source-drain current in proportion to the potential of the effective sensing node SN that is input to the third electrode of the amplifying transistor ST2.

When the collection period CP ends, the effective sensor FXdj may output the detection signal FSd through the readout lines RLd in response to the j-th write scan signals SWj during a readout period ROP. The j-th write scan signal SWj having a low level is supplied to the output transistor ST3 through the j-th write scan line SWLj during the readout period ROP. When the output transistor ST3 is turned on in response to the j-th write scan signal SWj having the low level, the detection signal FSd corresponding to a current flowing through the amplifying transistor ST2 may be output to the d-th readout line RLd.

When the readout period ROP ends, the effective sensor FXdj may be switched back to the idle period (IDP) state.

Referring again to FIGS. 4A and 4C, the ineffective sensor NFXgj is connected to the g-th readout line RLg (or, referred to as an ineffective readout line) from among the readout lines RL1 to RLh, the j-th write scan line SWLj, and the reset control line SRL.

The ineffective sensor NFXgj includes an ineffective light receiving element N_OPD (or, referred to as a second light receiving element) and an ineffective sensor drive circuit N_O_SD (or, referred to as a second sensor drive circuit). In one or more embodiments of the present disclosure, the ineffective sensor drive circuit N_O_SD of the ineffective sensor NFXgj may have a circuit configuration similar to that of the effective sensor drive circuit O_SD of the effective sensor FXdj. Accordingly, detailed description of the ineffective sensor drive circuit N_O_SD of the ineffective sensor NFXgj will be omitted.

The reset voltage line VRL may be commonly connected to the effective sensor drive circuit O_SD and the ineffective sensor drive circuit N_O_SD. In addition, the reset control line SRL may also be commonly connected to the effective sensor drive circuit O_SD and the ineffective sensor drive circuit N_O_SD. Accordingly, the reset transistors ST1 of the effective sensor drive circuit O_SD and the ineffective sensor drive circuit N_O_SD are concurrently (e.g., simultaneously) turned on in response to the reset control signal SR during the reset period RSP. That is, the effective sensing node SN of the effective sensor drive circuit O_SD and an ineffective sensing node N_SN of the ineffective sensor drive circuit N_O_SD may be reset to the reset voltage Vrst by the turned-on reset transistor ST1 during the reset period RSP.

In one or more embodiments of the present disclosure, the ineffective light receiving element N_OPD and the ineffective sensor drive circuit N_O_SD may be electrically isolated from each other. The ineffective light receiving element N_OPD may be electrically isolated from the ineffective sensor drive circuit N_O_SD at the ineffective sensing node N_SN.

When the ineffective sensing node N_SN of the ineffective sensor drive circuit N_O_SD is electrically isolated from the ineffective light receiving element N_OPD, the ineffective light receiving element N_OPD may not act as a load of the reset voltage line VRL. Accordingly, the magnitude of a load connected to the reset voltage line VRL may be reduced overall, and thus the potential of the effective sensing node SN may be rapidly reset to the reset voltage Vrst during the reset period RSP. In addition, the time it takes the potential of the effective sensing node SN of the effective sensor drive circuit O_SD sharing the reset voltage line VRL to be reset to the reset voltage Vrst may be reduced, and thus the overall response speed of an operation for recognizing biometric information may be improved.

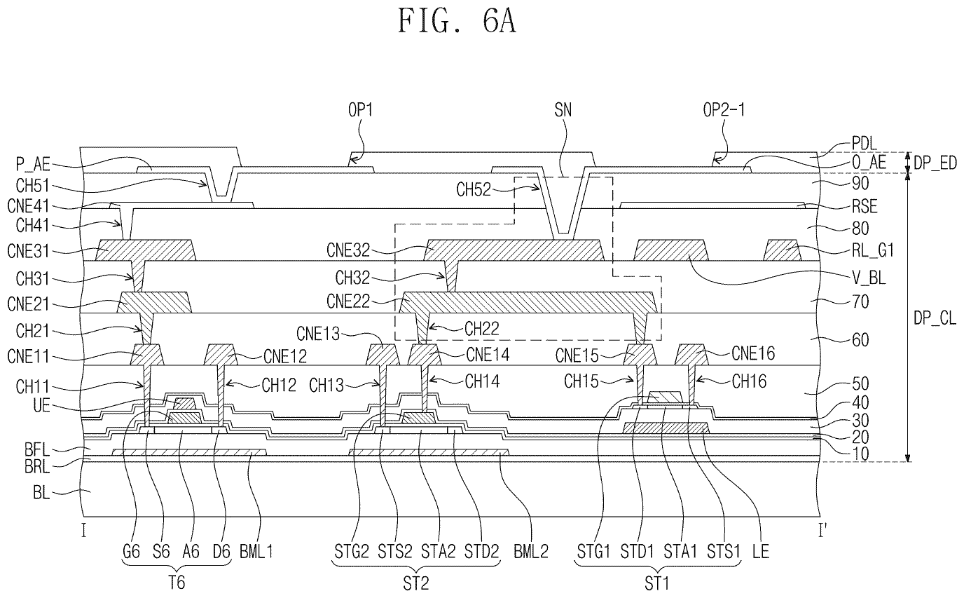

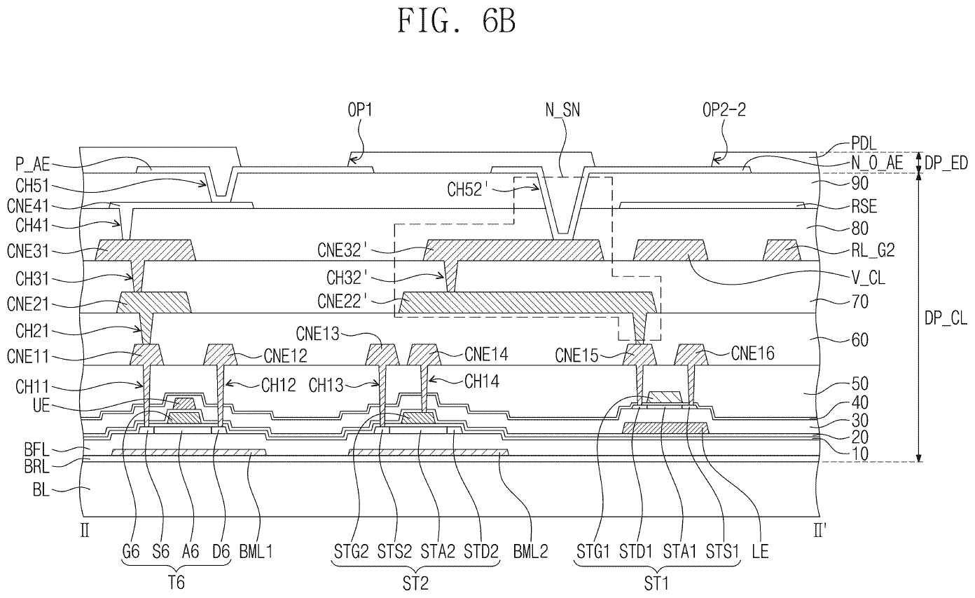

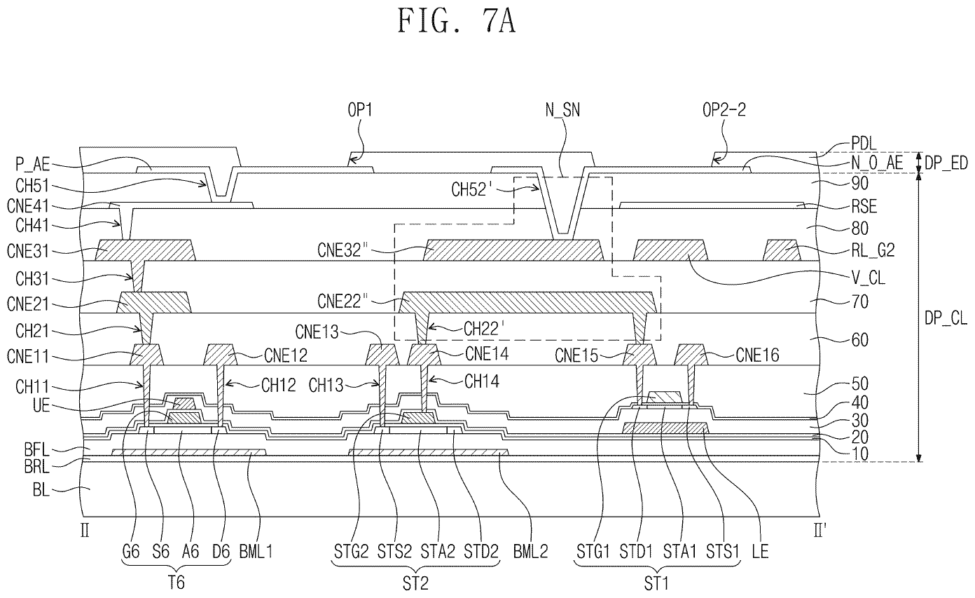

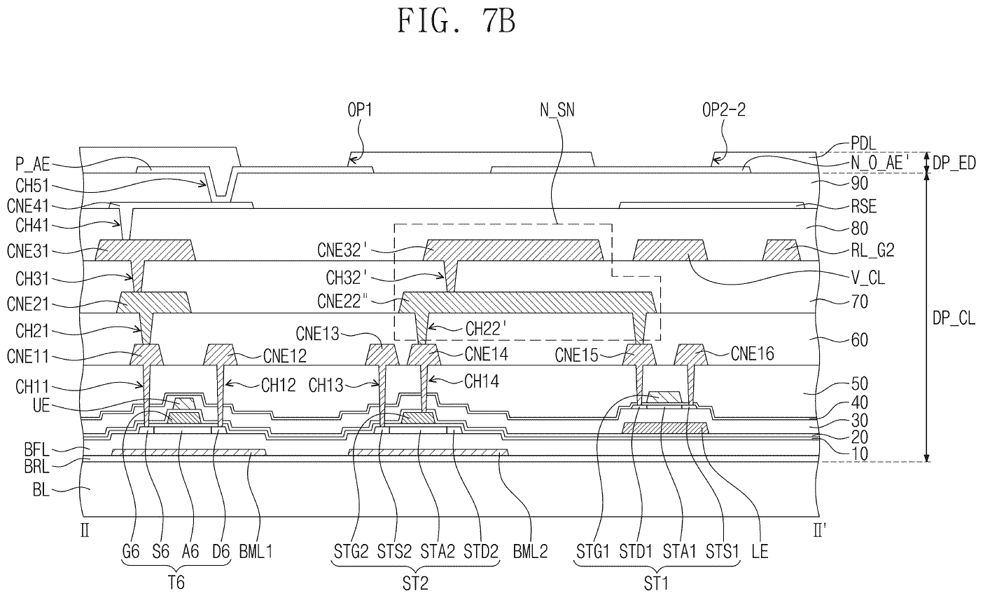

A non-connection structure of the ineffective light receiving element N_OPD and the ineffective sensor drive circuit N_O_SD will be described below in detail with reference to FIGS. 6A-7D.

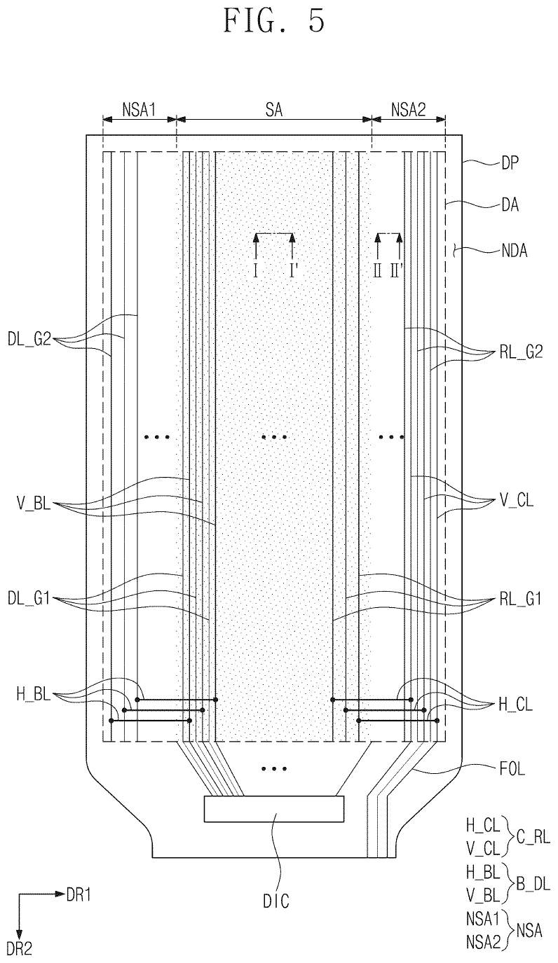

FIG. 5 is a plan view illustrating the display panel according to one or more embodiments of the present disclosure.

Referring to FIG. 5, the display panel DP includes the display region DA and the non-display region NDA. The display region DA may include the sensing region SA (or, the first region) and the non-sensing region NSA (or, the second region). In one or more embodiments of the present disclosure, the non-sensing region NSA may include the first non-sensing region NSA1 disposed on the first side of the sensing region SA and the second non-sensing region NSA2 disposed on the second side of the sensing region SA. The first and second non-sensing regions NSA1 and NSA2 may be spaced (e.g., spaced apart) from each other in the first direction DR1 with the sensing region SA therebetween.

The readout lines RL1 to RLh (refer to FIG. 3B) may be divided into a first group and a second group. The first group includes effective readout lines RL_G1 disposed in the sensing region SA, and the second group includes ineffective readout lines RL_G2 disposed in the non-sensing region NSA. The effective readout lines RL_G1 and the ineffective readout lines RL_G2 may extend in the second direction DR2 and are arranged along the first direction DR1. The effective readout lines RL_G1 and the ineffective readout lines RL_G2 are spaced (e.g., spaced apart) from each other in the first direction DR1.

The effective readout lines RL_G1 are electrically connected with the readout chip ROIC (refer to FIG. 3A). The display panel DP further includes a connecting line part C_RL electrically connecting the effective readout lines RL_G1 to the readout chip ROIC. The connecting line part C_RL includes a plurality of vertical connecting lines V_CL extending in the second direction DR2 and a plurality of horizontal connecting lines H_CL extending in the first direction DR1.

The vertical connecting lines V_CL may be disposed in the first or second non-sensing region NSA1 or NSA2. Although the vertical connecting lines V_CL are disposed in the second non-sensing region NSA2 in FIG. 5, the present disclosure is not limited thereto. The vertical connecting lines V_CL may be disposed in the first and second non-sensing regions NSA1 and NSA2, or may be disposed only in the first non-sensing region NSA1. The vertical connecting lines V_CL may be disposed parallel to the effective and ineffective readout lines RL_G1 and RL_G2. The vertical connecting lines V_CL may be electrically connected with the effective readout lines RL_G1 through the horizontal connecting lines H_CL. First ends of the horizontal connecting lines H_CL may be connected to the effective readout lines RL_G1, and second ends of the horizontal connecting lines H_CL may be connected to the vertical connecting lines V_CL.

In one or more embodiments of the present disclosure, the vertical connecting lines V_CL and the horizontal connecting lines H_CL are disposed in the display region DA. Accordingly, an increase in the width of the non-display region NDA when the vertical connecting lines V_CL and the horizontal connecting lines H_CL are disposed in the non-display region NDA may be prevented.

The connecting line part C_RL further includes fan-out lines FOL connecting the vertical connecting lines V_CL to the readout chip ROIC. The fan-out lines FOL may be disposed in the non-display region NDA.

The data lines DL1 to DLn (refer to FIG. 3B) may be divided into a first group and a second group. The first group includes data lines DL_G1 directly connected to the driver chip DIC (hereinafter, referred to as first group data lines), and the second group includes data lines DL_G2 connected to the driver chip DIC through a bridge line part B_DL (hereinafter, referred to as second group data lines). The first group data lines DL_G1 and the second group data lines DL_G2 extend in the second direction DR2 and are arranged along the first direction DR1. The first group data lines DL_G1 and the second group data lines DL_G2 are spaced (e.g., spaced apart) from each other in the first direction DR1.

The bridge line part B_DL includes a plurality of vertical bridge lines V_BL extending in the second direction DR2 and a plurality of horizontal bridge lines H_BL extending in the first direction DR1.

The vertical bridge lines V_BL may be disposed parallel to the first group data lines DL_G1 and the second group data lines DL_G2. The vertical bridge lines V_BL may be electrically connected with the second group data lines DL_G2 through the horizontal bridge lines H_BL. First ends of the horizontal bridge lines H_BL may be connected to the second group data lines DL_G2, and second ends of the horizontal bridge lines H_BL may be connected to the vertical bridge lines V_BL.

The vertical bridge lines V_BL and the first group data lines DL_G1 may extend to the non-display region NDA and may be connected with the driver chip DIC in the non-display region NDA.

The vertical bridge lines V_BL and the first group data lines DL_G1 disposed in the non-display region NDA may not overlap the fan-out lines FOL disposed in the non-display region NDA. Accordingly, parasitic capacitance acting on the fan-out lines FOL in the non-display region NDA may be reduced, and thus the biometric information sensing performance of the display device DD (refer to FIG. 3B) may be improved. In addition, because a portion of the connecting line part C_RL and a portion of the bridge line part B_DL are disposed in the display region DA, the width of the non-display region NDA may be decreased, and thus the area of dead space in the display panel DP may be decreased.

FIG. 6A is a sectional view illustrating a portion of a pixel and a portion of an effective sensor disposed in the sensing region according to one or more embodiments of the present disclosure. FIG. 6B is a sectional view illustrating a portion of a pixel and a portion of an ineffective sensor disposed in the non-sensing region according to one or more embodiments of the present disclosure.

Referring to FIGS. 6A and 6B, the display panel DP may include the base layer BL, the circuit layer DP_CL, and the element layer DP_ED.

The base layer BL may include a synthetic resin layer. The synthetic resin layer may include a thermosetting resin. In particular, the synthetic resin layer may be a polyimide-based resin layer, and the material thereof is not particularly limited. The synthetic resin layer may include at least one of an acrylic resin, a methacrylic resin, a polyisoprene resin, a vinyl resin, an epoxy resin, a urethane-based resin, a celluosic resin, a siloxane-based resin, a polyamide resin, or a perylene-based resin. In addition, the base layer BL may include a glass substrate, a metal substrate, and/or an organic/inorganic composite substrate.

At least one inorganic layer is formed on the upper surface of the base layer BL. The inorganic layer may include at least one of aluminum oxide, titanium oxide, silicon oxide, silicon oxy nitride, zirconium oxide, or hafnium oxide. The inorganic layer may be formed of multiple layers.

The circuit layer DP_CL is disposed on the base layer BL. The circuit layer DP_CL includes a barrier layer BRL disposed on the base layer BL. The barrier layer BRL prevents infiltration of foreign matter from the outside. The barrier layer BRL may include a silicon oxide layer and/or a silicon nitride layer. A plurality of silicon oxide layers and a plurality of silicon nitride layers may be provided. The silicon oxide layers and the silicon nitride layers may be alternately stacked one above another.

Referring to FIGS. 6A and 6B, first and second shielding layers BML1 and BML2 may be disposed on the barrier layer BRL. The first and second shielding layers BML1 and BML2 may overlap the sixth transistor T6 and the amplifying transistor ST2, respectively, in a thickness direction of the base layer BL (e.g., a third direction DR3). Each of the first and second shielding layers BML1 and BML2 may include metal and may receive a constant voltage. When the constant voltage is applied to the first and second shielding layers BML1 and BML2, the threshold voltages Vth of the sixth transistor T6 and the amplifying transistor ST2 disposed over the first and second shielding layers BML1 and BML2 may remain unchanged.

The first and second shielding layers BML1 and BML2 may block light incident toward the sixth transistor T6 and the amplifying transistor ST2. For example, each of the first and second shielding layers BML1 and BML2 may include reflective metal. In one or more embodiments of the present disclosure, the first and second shielding layers BML1 and BML2 may be omitted.

A buffer layer BFL may be disposed on the barrier layer BRL covering the first and second shielding layers BML1 and BML2. The buffer layer BFL may include an inorganic layer. The buffer layer BFL may cover the first and second shielding layers BML1 and BML2. The buffer layer BFL may include silicon oxide layers and silicon nitride layers. The silicon oxide layers and the silicon nitride layers may be alternately stacked one above another.

A semiconductor pattern is disposed on the buffer layer BFL. Hereinafter, the semiconductor pattern directly disposed on the buffer layer BFL is defined as a first semiconductor pattern. The first semiconductor pattern may include a silicon semiconductor. The first semiconductor pattern may include poly silicon. However, without being limited thereto, the first semiconductor pattern may include amorphous silicon.

In FIGS. 6A and 6B, the first semiconductor pattern includes a semiconductor pattern portion of the sixth transistor T6 (hereinafter, referred to as the first semiconductor patter portion) and a semiconductor pattern portion of the amplifying transistor ST2 (hereinafter, referred to as the second semiconductor pattern portion). The first and second semiconductor pattern portions may be formed through the same process. The first and second semiconductor pattern portions have different electrical properties depending on whether doping is performed or not. Each of the first and second semiconductor pattern portions may be doped with an N-type dopant or a P-type dopant. A P-type transistor includes a doped region doped with a P-type dopant, and an N-type transistor includes a doped region doped with an N-type dopant.

Each of the first and second semiconductor pattern portions may include a highly doped region and a lightly doped region. The conductivity of the highly doped region is higher than the conductivity of the lightly doped region. Substantially, the highly doped region of the sixth transistor T6 serves as an electrode or a signal line, and the lightly doped region of the sixth transistor T6 corresponds to a channel region of the sixth transistor T6. In other words, one partial region of the first semiconductor pattern portion may be the channel region A6 of the sixth transistor T6, and another partial region of the first semiconductor pattern portion may be a source region S6 (or, a first electrode) or a drain region D6 (or, a second electrode) of the sixth transistor T6. The lightly doped region of the second semiconductor pattern portion may be a channel region STA2 of the amplifying transistor ST2, and the highly doped region of the second semiconductor pattern portion may be a source region STS2 (or, a first electrode) or a drain region STD2 (or, a second electrode) of the amplifying transistor ST2.

Although the first and second semiconductor pattern portions are spaced (e.g., spaced apart) from each other in FIGS. 6A and 6B, the first and second semiconductor pattern portions may have a one-body shape when viewed from above the plane.

A first insulating layer 10 is disposed on the buffer layer BFL covering the first and second semiconductor pattern portions. The first insulating layer 10 commonly overlaps the plurality of pixels PX (refer to FIG. 3B) and covers the first and second semiconductor pattern portions. The first insulating layer 10 may be an inorganic layer and/or an organic layer and may have a single-layer structure or a multi-layer structure. The first insulating layer 10 may include at least one of aluminum oxide, titanium oxide, silicon oxide, silicon oxy nitride, zirconium oxide, or hafnium oxide. In this embodiment, the first insulating layer 10 may be a single silicon oxide layer. Not only the first insulating layer 10 but also insulating layers of the circuit layer DP_CL that will be described below may be inorganic layers and/or organic layers and may have a single-layer structure or a multi-layer structure. The inorganic layers may include at least one of the aforementioned materials.

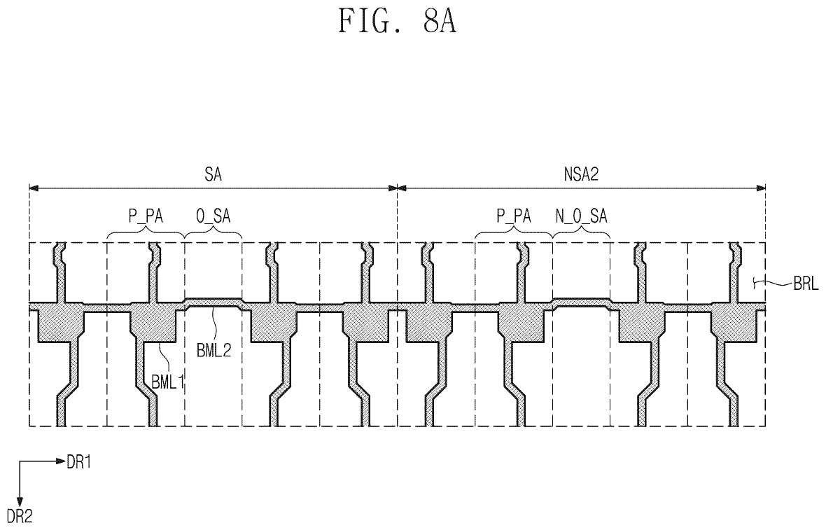

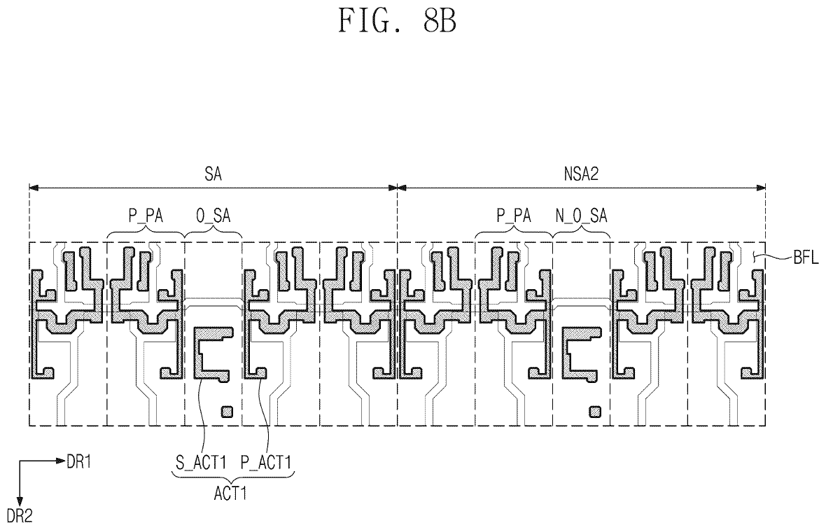

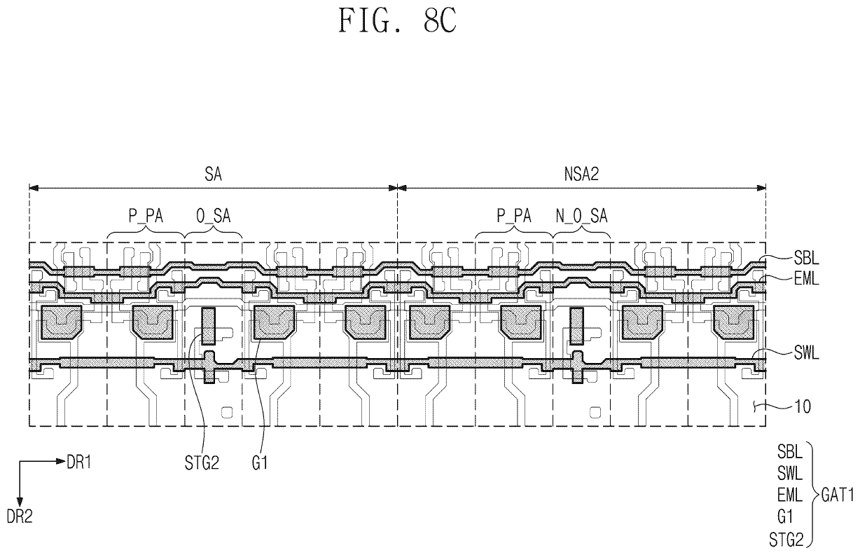

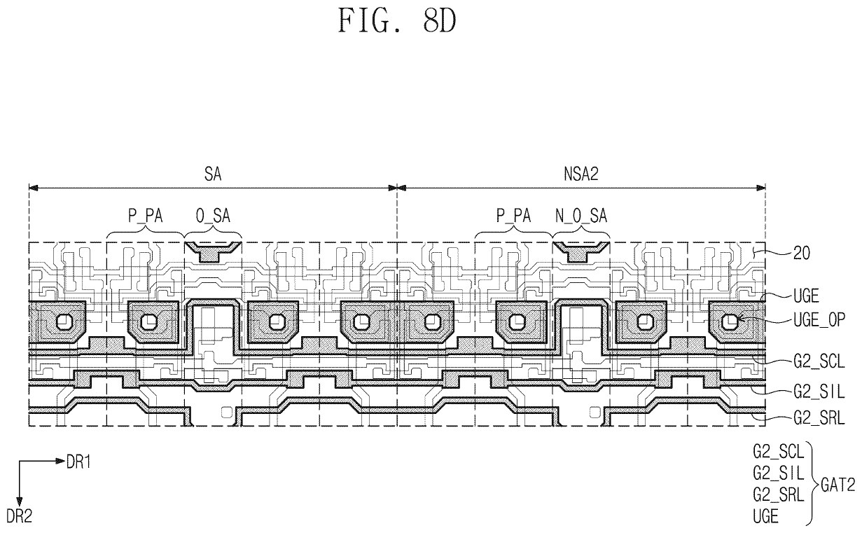

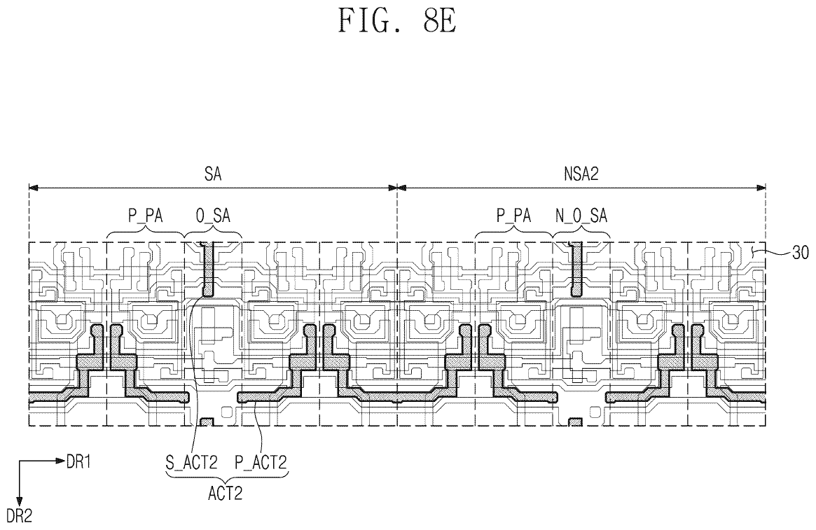

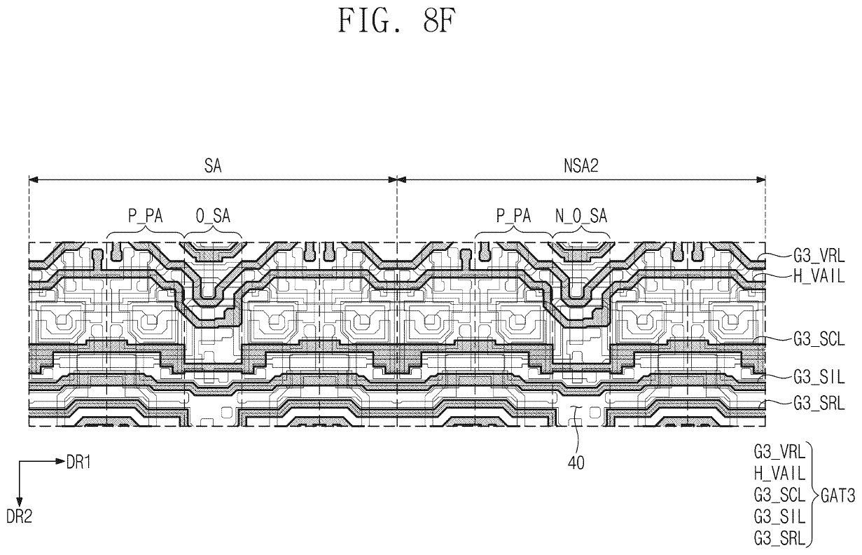

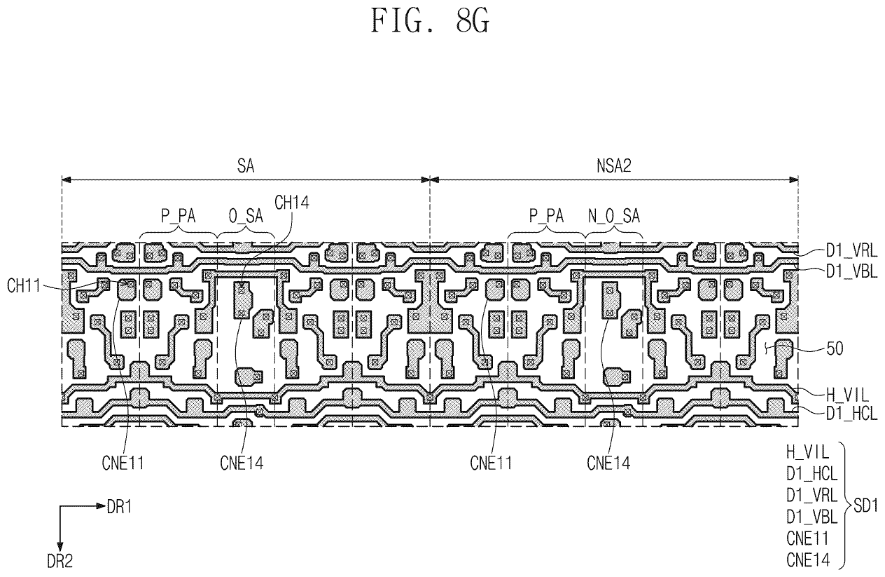

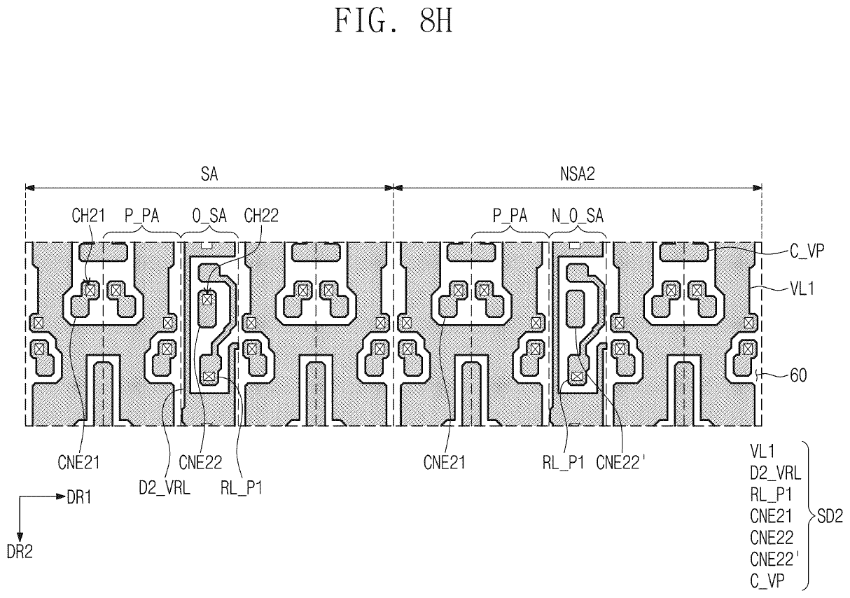

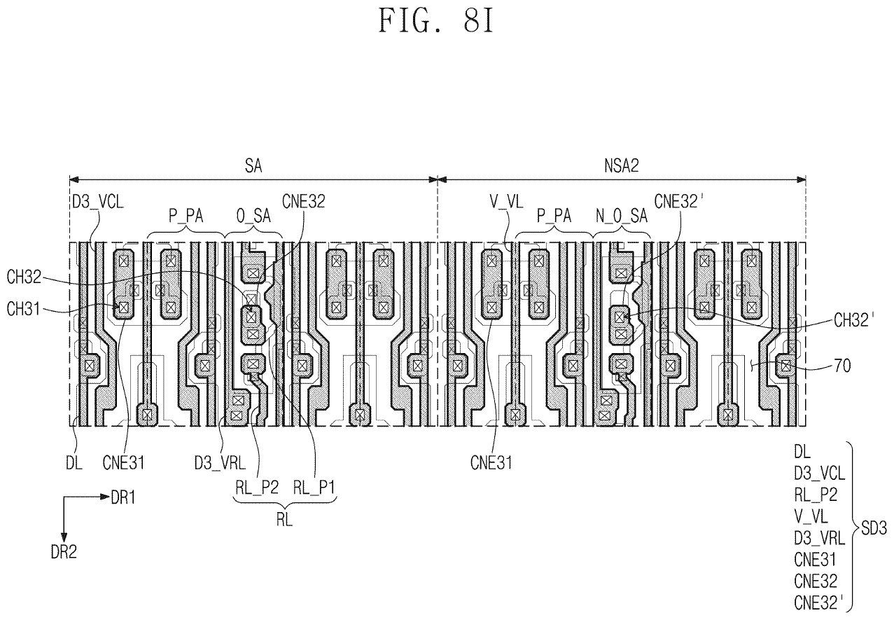

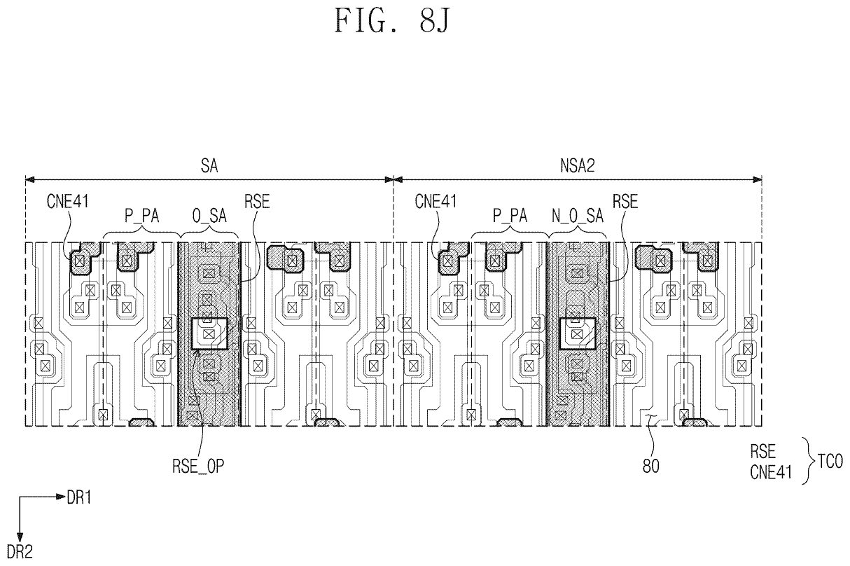

A gate electrode G6 (referred to as a third electrode or a sixth gate electrode) of the sixth transistor T6 and a gate electrode STG2 (referred to as a third electrode or a second sensor gate electrode) of the amplifying transistor ST2 are disposed on the first insulating layer 10. The gate electrodes G6 and STG2 may be portions of a first gate pattern layer GAT1 (refer to FIG. 8C). The gate electrode G6 of the sixth transistor T6 overlaps the channel region A6 of the sixth transistor T6 in the thickness direction of the base layer BL (e.g., the third direction DR3). The gate electrode G6 of the sixth transistor T6 may serve as a mask in a process of doping the first semiconductor pattern portion. The gate electrode STG2 of the amplifying transistor ST2 overlaps the channel region STA2 of the amplifying transistor ST2 in the thickness direction of the base layer BL (e.g., the third direction DR3). The gate electrode STG2 of the amplifying transistor ST2 may serve as a mask in a process of doping the second semiconductor pattern portion.

A second insulating layer 20 is disposed on the first insulating layer 10 to cover the gate electrodes G6 and STG2. The second insulating layer 20 commonly overlaps the plurality of pixels PX. The second insulating layer 20 may be an inorganic layer and/or an organic layer and may have a single-layer structure or a multi-layer structure. In this embodiment, the second insulating layer 20 may be a single silicon oxide layer.

An upper electrode UE and a lower electrode LE may be disposed on the second insulating layer 20. The upper electrode UE may overlap the gate electrode G6 of the sixth transistor T6 in the thickness direction of the base layer BL (e.g., the third direction DR3). The lower electrode LE may overlap the semiconductor pattern portion of the reset transistor ST1 in the thickness direction of the base layer BL (e.g., the third direction DR3). The lower electrode LE may block light incident toward the semiconductor pattern portion of the reset transistor ST1.

The upper electrode UE and the lower electrode LE may be portions of a second gate pattern layer GAT2 (refer to FIG. 8D), or may be portions of a doped semiconductor pattern. In one or more embodiments of the present disclosure, the upper electrode UE and the lower electrode LE may be omitted.

In one or more embodiments of the present disclosure, the second insulating layer 20 may be replaced with an insulating pattern. The upper electrode UE and the lower electrode LE are disposed on the insulating pattern. The upper electrode UE and the lower electrode LE may serve as a mask that forms the insulating pattern from the second insulating layer 20.

A third insulating layer 30 is disposed on the second insulating layer 20 to cover the upper electrode UE and the lower electrode LE. In this embodiment, the third insulating layer 30 may be a single silicon oxide layer.

A semiconductor pattern is disposed on the third insulating layer 30. Hereinafter, the semiconductor pattern directly disposed on the third insulating layer 30 may be referred to as a second semiconductor pattern. The second semiconductor pattern may include a metal oxide semiconductor. The metal oxide semiconductor may include a crystalline or amorphous oxide semiconductor. For example, the metal oxide semiconductor may include metal oxide of zinc (Zn), indium (In), gallium (Ga), tin (Sn), and/or titanium (Ti). Alternatively, the metal oxide semiconductor may include a mixture of metal such as zinc (Zn), indium (In), gallium (Ga), tin (Sn), and/or titanium (Ti) and/or oxide thereof. The metal oxide semiconductor may include indium tin oxide (ITO), indium gallium zinc oxide (IGZO), zinc oxide (ZnO), indium zinc oxide (IZO), zinc indium oxide (ZIO), indium oxide (InO), titanium oxide (TiO), indium zinc tin oxide (IZTO), and/or zinc tin oxide (ZTO).

In FIG. 6A, the second semiconductor pattern includes the semiconductor pattern portion of the reset transistor ST1. The semiconductor pattern portion of the reset transistor ST1 may include a plurality of regions distinguished depending on whether metal oxide is reduced or not. A region where metal oxide is reduced (hereinafter, referred to as the reduced region) has a higher conductivity than a region where metal oxide is not reduced (hereinafter, referred to as the non-reduced region). The reduced region substantially corresponds to a source region STS1 (or, a first electrode) or a drain region STD1 (or, a second electrode) of the reset transistor ST1, and the non-reduced region substantially corresponds to a channel region STA1 of the semiconductor pattern portion of the reset transistor ST1.

A fourth insulating layer 40 is disposed on the third insulating layer 30 to cover the semiconductor pattern portion of the reset transistor ST1. The fourth insulating layer 40 commonly overlaps the plurality of pixels PX (refer to FIG. 3B) and covers the second semiconductor pattern. A gate electrode STG1 (or, a third electrode) of the reset transistor ST1 is disposed on the fourth insulating layer 40. In this embodiment, the gate electrode STG1 of the reset transistor ST1 may be a portion of a third gate pattern layer GAT3 (refer to FIG. 8F). The gate electrode STG1 of the reset transistor ST1 overlaps the channel region STA1 of the reset transistor ST1 in the thickness direction of the base layer BL (e.g., the third direction DR3).

A fifth insulating layer 50 is disposed on the fourth insulating layer 40 to cover the gate electrode STG1 of the reset transistor ST1. In this embodiment, the fifth insulating layer 50 may include a silicon oxide layer and a silicon nitride layer. The fifth insulating layer 50 may include a plurality of silicon oxide layers and a plurality of silicon nitride layers alternately stacked one above another.

A first connecting electrode may be disposed on the fifth insulating layer 50. In one or more embodiments of the present disclosure, the first connecting electrode includes a first-first connecting electrode CNE11, a first-second connecting electrode CNE12, a first-third connecting electrode CNE13, a first-fourth connecting electrode CNE14 (referred to as a first or second intermediate connecting electrode), a first-fifth connecting electrode CNE15, and a first-sixth connecting electrode CNE16. The first-first and first-second connecting electrodes CNE11 and CNE12 are connected to the source region S6 and the drain region D6 of the sixth transistor T6 through first-first and first-second contact holes CH11 and CH12, respectively, which penetrate the first to fifth insulating layers 10 to 50. The first-third connecting electrode CNE13 is connected to the source region STS2 of the amplifying transistor ST2 through a first-third contact hole CH13 penetrating the first to fifth insulating layers 10 to 50.

The first-fourth connecting electrode CNE14 is connected to the gate electrode STG2 of the amplifying transistor ST2 through a first-fourth contact hole CH14 (or, referred to as a first effective contact hole) penetrating the second to fifth insulating layers 20 to 50. The first-fifth and first-sixth connecting electrodes CNE15 and CNE16 are connected to the source region STS1 and the drain region STD1 of the reset transistor ST1 through first-fifth and first-sixth contact holes CH15 and CH16, respectively, which penetrate the fourth and fifth insulating layers 40 and 50.

The first-first to first-sixth connecting electrodes CNE11 to CNE16 may be portions of a first data pattern layer SD1 (refer to FIG. 8G). A sixth insulating layer 60 (or, a first VIA insulating layer) is disposed on the fifth insulating layer 50 to cover the first-first to first-sixth connecting electrodes CNE11 to CNE16. The sixth insulating layer 60 may be an organic layer and may have a single-layer structure or a multi-layer structure. The sixth insulating layer 60 may be a single polyimide-based resin layer. Without being limited thereto, the sixth insulating layer 60 may include at least one of an acrylic resin, a methacrylic resin, a polyisoprene resin, a vinyl resin, an epoxy resin, a urethane-based resin, a celluosic resin, a siloxane-based resin, a polyamide resin, or a perylene-based resin.

A second connecting electrode is disposed on the sixth insulating layer 60. In one or more embodiments of the present disclosure, the second connecting electrode includes a second-first connecting electrode CNE21, a second-second connecting electrode CNE22 (or, a first effective connecting electrode), and a first ineffective connecting electrode CNE22′. In the sensing region SA and the second non-sensing region NSA2, the second-first connecting electrode CNE21 is connected to the first-first connecting electrode CNE11 through a second-first contact hole CH21 penetrating the sixth insulating layer 60. In the sensing region SA, the second-second connecting electrode CNE22 is connected to the gate electrode STG2 (or, the third electrode) of the amplifying transistor ST2 through a second-second contact hole CH22 penetrating the sixth insulating layer 60. At the effective sensing node SN of the sensing region SA, the second-second connecting electrode CNE22 may electrically connect the gate electrode STG2 of the amplifying transistor ST2 and the drain region STD1 (or, the second electrode) of the reset transistor ST1.

At the ineffective sensing node N_SN of the second non-sensing region NSA2, the first ineffective connecting electrode CNE22′ is not connected to the first-fourth connecting electrode CNE14. That is, a contact hole for connecting the first ineffective connecting electrode CNE22′ to the first-fourth connecting electrode CNE14 is not provided in the sixth insulating layer 60. At the ineffective sensing node N_SN of the second non-sensing region NSA2, the first-fourth connecting electrode CNE14 is completely covered by the sixth insulating layer 60 without being exposed. Accordingly, the first ineffective connecting electrode CNE22′ is not electrically connected to the gate electrode STG2 of the amplifying transistor ST2. The first ineffective connecting electrode CNE22′ may be electrically connected to the drain region STD1 (or, the second electrode) of the reset transistor ST1, but the present disclosure is not limited thereto. That is, the first ineffective connecting electrode CNE22′ may not be electrically connected to the source region STS1 and/or the drain region STD1 (or, the second electrode) of the reset transistor ST1.

The second-first connecting electrode CNE21, the second-second connecting electrode CNE22 (or, the first effective connecting electrode), and the first ineffective connecting electrode CNE22′ may be portions of a second data pattern layer SD2 (refer to FIG. 8H). A seventh insulating layer 70 (or, a second VIA insulating layer) is disposed on the sixth insulating layer 60 to cover the second-first connecting electrode CNE21, the second-second connecting electrode CNE22, and the first ineffective connecting electrode CNE22′. The seventh insulating layer 70 may be an organic layer and may have a single-layer structure or a multi-layer structure.

A third connecting electrode is disposed on the seventh insulating layer 70. In one or more embodiments of the present disclosure, the third connecting electrode includes a third-first connecting electrode CNE31, a third-second connecting electrode CNE32 (or, a second effective connecting electrode), and a second ineffective connecting electrode CNE32′. In the sensing region SA and the second non-sensing region NSA2, the third-first connecting electrode CNE31 is connected to the second-first connecting electrode CNE21 through a third-first contact hole CH31 penetrating the seventh insulating layer 70. At the effective sensing node SN of the sensing region SA, the third-second connecting electrode CNE32 (or, the second effective connecting electrode) is connected to the second-second connecting electrode CNE22 (or, the first effective connecting electrode) through a third-second contact hole CH32 (or, a second effective contact hole) penetrating the seventh insulating layer 70. At the ineffective sensing node N_SN of the second non-sensing region NSA2, the second ineffective connecting electrode CNE32′ is connected to the first ineffective connecting electrode CNE22′ through a third-third contact hole CH32′ penetrating the seventh insulating layer 70.

Because the first ineffective connecting electrode CNE22′ is not connected to the gate electrode STG2 of the amplifying transistor ST2 even though the second ineffective connecting electrode CNE32′ is connected to the first ineffective connecting electrode CNE22′, the second ineffective connecting electrode CNE32′ is not able to be electrically connected with the gate electrode STG2 of the amplifying transistor ST2.

The readout lines RL_G1 and RL_G2, the vertical bridge lines V_BL, the vertical connecting lines V_CL, and the data lines DL_G1 and DL_G2 may be additionally disposed on the seventh insulating layer 70.

The third-first connecting electrode CNE31, the third-second connecting electrode CNE32, the second ineffective connecting electrode CNE32′, the readout lines RL_G1 and RL_G2, the vertical bridge lines V_BL, the vertical connecting lines V_CL, and the data lines DL_G1 and DL_G2 may be portions of a third data pattern layer SD3 (refer to FIG. 8I). An eighth insulating layer 80 is disposed on the seventh insulating layer 70 to cover the third-first connecting electrode CNE31, the third-second connecting electrode CNE32, and the second ineffective connecting electrode CNE32′, the readout lines RL_G1 and RL_G2, the vertical bridge lines V_BL, the vertical connecting lines V_CL, and the data lines DL_G1 and DL_G2. The eighth insulating layer 80 may be an organic layer and may have a single-layer structure or a multi-layer structure.

A fourth connecting electrode and a shielding electrode RSE may be disposed on the eighth insulating layer 80. The fourth connecting electrode may include a fourth-first connecting electrode CNE41. The fourth-first connecting electrode CNE41 is connected with the third-first connecting electrode CNE31 through a fourth-first contact hole CH41 penetrating the eighth insulating layer 80. The shielding electrode RSE may be disposed to overlap the readout lines RL_G1 and RL_G2 when viewed from above the plane (e.g., in a plan view).

The fourth-first connecting electrode CNE41 and the shielding electrode RSE may be portions of a transparent pattern layer TCO (refer to FIG. 8J). A ninth insulating layer 90 is disposed on the eighth insulating layer 80 to cover the fourth-first connecting electrode CNE41 and the shielding electrode RSE. The ninth insulating layer 90 may be an organic layer and may have a single-layer structure or a multi-layer structure. The eighth and ninth insulating layers 80 and 90 may be referred to as a third VIA insulating layer. In a structure in which the transparent pattern layer TCO is omitted, only the eight insulating layer 80 may be referred to as the third VIA insulating layer.

The element layer DP_ED is disposed on the circuit layer DP_CL. The element layer DP_ED may include a pixel anode electrode P_AE, an effective anode electrode O_AE, and an ineffective anode electrode N_O_AE that are disposed on the ninth insulating layer 90.

In the sensing region SA and the second non-sensing region NSA2, the pixel anode electrode P_AE is connected to the fourth-first connecting electrode CNE41 through a fifth-first contact hole CH51 penetrating the ninth insulating layer 90. Accordingly, the light emitting element ED of each pixel PX may be electrically connected with the source region S6 of the sixth transistor T6. At the effective sensing node SN of the sensing region SA, the effective anode electrode O_AE is connected to the third-second connecting electrode CNE32 through a fifth-second contact hole CH52 penetrating the eighth and ninth insulating layers 80 and 90. Accordingly, the effective light receiving element OPD of each effective sensor FX may be electrically connected with the gate electrode STG2 of the amplifying transistor ST2.

In one or more embodiments, at the ineffective sensing node N_SN of the second non-sensing region NSA2, the ineffective anode electrode N_O_AE is connected to the second ineffective connecting electrode CNE32′ through a fifth-third contact hole CH52′ penetrating the eighth and ninth insulating layers 80 and 90. However, because the first ineffective connecting electrode CNE22′ is not connected with the gate electrode STG2 of the amplifying transistor ST2, the ineffective light receiving element N_OPD of each ineffective sensor NFX may be electrically isolated from the gate electrode STG2 of the amplifying transistor ST2.

The element layer DP_ED further includes a pixel defining layer PDL disposed on the circuit layer DP_CL. The pixel defining layer PDL may include a light emitting opening OP1 defined to correspond to the pixel anode electrode P_AE, a first light receiving opening OP2-1 defined to correspond to the effective anode electrode O_AE, and a second light receiving opening OP2-2 defined to correspond to the ineffective anode electrode N_O_AE. The light emitting opening OP1 exposes at least a portion of the pixel anode electrode P_AE. The first light receiving opening OP2-1 exposes a portion of the effective anode electrode O_AE in the sensing region SA, the second light receiving opening OP2-2 exposes a portion of the ineffective anode electrode N_O_AE in the second non-sensing region NSA2.

FIGS. 7A and 7B are sectional views illustrating a portion of a pixel and a portion of an ineffective sensor disposed in the non-sensing region according to one or more embodiments of the present disclosure. From among the components illustrated in FIGS. 7A and 7B, components identical to the components illustrated in FIG. 6B will be assigned with identical reference numerals, and detailed description thereabout will be omitted

As illustrated in FIG. 7A, the second connecting electrode is disposed on the sixth insulating layer 60. In one or more embodiments of the present disclosure, the second connecting electrode includes the second-first connecting electrode CNE21, the second-second connecting electrode CNE22 (or, the first effective connecting electrode), and a first ineffective connecting electrode CNE22″. At the ineffective sensing node N_SN of the second non-sensing region NSA2, the first ineffective connecting electrode CNE22″ is connected to the gate electrode STG2 (or, the third electrode) of the amplifying transistor ST2 through a second-third contact hole CH22′ penetrating the sixth insulating layer 60. At the ineffective sensing node N_SN of the second non-sensing region NSA2, the first ineffective connecting electrode CNE22″ may electrically connect the drain region STD1 (or, the second electrode) of the reset transistor ST1 and the gate electrode STG2 of the amplifying transistor ST2.

The third connecting electrode is disposed on the seventh insulating layer 70. In one or more embodiments of the present disclosure, the third connecting electrode includes the third-first connecting electrode CNE31, the third-second connecting electrode CNE32 (or, the second effective connecting electrode), and a second ineffective connecting electrode CNE32″. At the ineffective sensing node N_SN of the second non-sensing region NSA2, the second ineffective connecting electrode CNE32″ is not connected to the first ineffective connecting electrode CNE22″. That is, a contact hole for connecting the second ineffective connecting electrode CNE32″ to the first ineffective connecting electrode CNE22″ is not provided in the seventh insulating layer 70.

Accordingly, because the second ineffective connecting electrode CNE32″ is not connected to the first ineffective connecting electrode CNE22″ even though the first ineffective connecting electrode CNE22″ is connected to the gate electrode STG2 of the amplifying transistor ST2, the second ineffective connecting electrode CNE32″ is not able to be electrically connected with the gate electrode STG2 of the amplifying transistor ST2.

At the ineffective sensing node N_SN of the second non-sensing region NSA2, the ineffective anode electrode N_O_AE is connected to the second ineffective connecting electrode CNE32″ through the fifth-third contact hole CH52′ penetrating the eighth and ninth insulating layers 80 and 90. However, because the second ineffective connecting electrode CNE32″ is not connected with the first ineffective connecting electrode CNE22″, the ineffective light receiving element N_OPD of each ineffective sensor NFX may be electrically isolated from the gate electrode STG2 of the amplifying transistor ST2.

Referring to FIG. 7B, the second connecting electrode is disposed on the sixth insulating layer 60. In one or more embodiments of the present disclosure, the second connecting electrode includes the second-first connecting electrode CNE21, the second-second connecting electrode CNE22 (or, the first effective connecting electrode), and the first ineffective connecting electrode CNE22″. At the ineffective sensing node N_SN of the second non-sensing region NSA2, the first ineffective connecting electrode CNE22″ is connected to the gate electrode STG2 of the amplifying transistor ST2 through the second-third contact hole CH22′ penetrating the sixth insulating layer 60.

The third connecting electrode is disposed on the seventh insulating layer 70. In one or more embodiments of the present disclosure, the third connecting electrode includes the third-first connecting electrode CNE31, the third-second connecting electrode CNE32 (or, the second effective connecting electrode), and the second ineffective connecting electrode CNE32′. At the ineffective sensing node N_SN of the second non-sensing region NSA2, the second ineffective connecting electrode CNE32′ is connected to the first ineffective connecting electrode CNE22″ through the third-third contact hole CH32′ penetrating the seventh insulating layer 70.

At the ineffective sensing node N_SN of the second non-sensing region NSA2, an ineffective anode electrode N_O_AE′ is not connected to the second ineffective connecting electrode CNE32′. That is, a contact hole for connecting the ineffective anode electrode N_O_AE′ to the second ineffective connecting electrode CNE32′ is not provided in the eighth and ninth insulating layers 80 and 90. Accordingly, even though the first and second ineffective connecting electrodes CNE22″ and CNE32′ are electrically connected with the gate electrode STG2 of the amplifying transistor ST2, the ineffective light receiving element N_OPD of each ineffective sensor NFX may be electrically isolated from the gate electrode STG2 of the amplifying transistor ST2.

At the ineffective sensing node N_SN, the ineffective light receiving element N_OPD may not act as a load of the reset voltage line VRL when the ineffective sensor drive circuit N_O_SD and the ineffective light receiving element N_OPD are electrically isolated from each other. Accordingly, the magnitude of a load connected to the reset voltage line VRL may be reduced overall, and thus the potential of the effective sensing node SN may be rapidly reset to the reset voltage Vrst during the reset period RSP. In addition, the time it takes the potential of the effective sensing node SN of the effective sensor drive circuit O_SD sharing the reset voltage line VRL to be reset to the reset voltage Vrst may be reduced, and thus the overall response speed of an operation for recognizing biometric information may be improved.

FIGS. 8A-8J are plan views illustrating a stacking process of the circuit layer according to one or more embodiments of the present disclosure.

FIGS. 8A-8J illustrate a part of the pixel drive circuits P_PD (refer to FIG. 4A) and a part of the effective sensor drive circuits O_SD (refer to FIG. 4A) that are disposed in the sensing region SA and a part of the pixel drive circuits P_PD (refer to FIG. 4A) and a part of the ineffective sensor drive circuits N_O_SD (refer to FIG. 4A) that are disposed in the second non-sensing region NSA2. Eight first circuit regions P_PA corresponding to eight pixel drive circuits P_PD, respectively, a second circuit region O_SA corresponding to the effective sensor drive circuit O_SD in the sensing region SA, a third circuit region N_O_SA corresponding to an ineffective sensor drive circuit N_O_PD in the second non-sensing region NSA2 are defined in FIGS. 8A-8J. In FIGS. 8A-8J, the boundaries between the first to third circuit regions P_PA, O_SA, and N_O_SA are illustrated by dotted lines.

Referring to FIG. 8A, the first and second shielding layers BML1 and BML2 may be formed on the barrier layer BRL. The first and second shielding layers BML1 and BML2 may be conductive patterns having a light blocking function. The first shielding layer BML1 may be disposed under at least one of the transistors T1 to T7 (refer to FIG. 4A) included in each of the first circuit regions P_PA and may block light incident to the transistors T1 to T7 from the outside. The second shielding layer BML2 may be disposed under at least one of the transistors ST1 to ST3 (refer to FIG. 4A) included in each of the second and third circuit regions O_SA and N_O_SA and may block light incident to the transistors ST1 to ST3 from the outside.

Referring to FIGS. 8A and 8B, the first and second shielding layers BML1 and BML2 may be covered by the buffer layer BFL. A first semiconductor pattern layer ACT1 may be disposed on the buffer layer BFL. The first semiconductor pattern layer ACT1 on the buffer layer BFL may overlap the first and second shielding layers BML1 and BML2. The first semiconductor pattern layer ACT1 may include a silicon semiconductor. For example, the silicon semiconductor may include amorphous silicon or polycrystalline silicon. For example, the first semiconductor pattern layer ACT1 may include low-temperature polycrystalline silicon (LTPS).

The first semiconductor pattern layer ACT1 includes a first semiconductor pattern portion P_ACT1 disposed in each of the first circuit regions P_PA and a second semiconductor pattern portion S_ACT1 disposed in each of the second and third circuit regions O_SA and N_O_SA.

Referring to FIG. 8C, the first gate pattern layer GAT1 may be disposed on the first insulating layer 10. The first gate pattern layer GAT1 may include metal, an alloy, conductive metal oxide, and/or a transparent conductive material. For example, the first gate pattern layer GAT1 may include silver (Ag), an alloy containing silver, molybdenum (Mo), an alloy containing molybdenum, aluminum (AI), an alloy containing aluminum, aluminum nitride (AlN), tungsten (W), tungsten nitride (WN), copper (Cu), indium tin oxide (ITO), and/or indium zinc oxide (IZO), but is not particularly limited thereto.

The first gate pattern layer GAT1 may include a first gate wiring SBL, a second gate wiring EML, a third gate wiring SWL, a first gate electrode G1, and a second sensor gate electrode STG2.

Each of the first to third gate wirings SBL, EML, and SWL may extend in the first direction DR1. The first gate wiring SBL corresponds to the j-th black scan line SBLj of FIG. 4A. For example, the j-th black scan signal SBj (refer to FIG. 4A) may be provided to the first gate wiring SBL. The first gate wiring SBL may constitute the seventh transistor T7 of FIG. 4A together with the first semiconductor pattern portion P_ACT1.

The second gate wiring EML corresponds to the j-th emission control line EMLj of FIG. 4A. For example, the j-th emission control signal EMj (refer to FIG. 4A) may be provided to the second gate wiring EML. The second gate wiring EML may constitute the fifth and sixth transistors T5 and T6 of FIG. 4A together with the first semiconductor pattern portion P_ACT1.

The third gate wiring SWL corresponds to the j-th write scan line SWLj of FIG. 4A. For example, the j-th write scan signal SWj (refer to FIG. 4A) may be provided to the third gate wiring SWL. The third gate wiring SWL may constitute the second transistor T2 of FIG. 4A together with the first semiconductor pattern portion P_ACT1 and may constitute the output transistor ST3 of FIG. 4A together with the second semiconductor pattern portion S_ACT1.

The first gate electrode G1 and the second sensor gate electrode STG2 may be disposed in an island shape. The first gate electrode G1 may constitute the first transistor T1 of FIG. 4A together with the first semiconductor pattern portion P_ACT1. The second sensor gate electrode STG2 may constitute the amplifying transistors ST2 of the effective sensor FXdj and the ineffective sensor NFXgj illustrated in FIG. 4A together with the second semiconductor pattern portion S_ACT1. The second sensor gate electrode STG2 may correspond to the gate electrode STG2 of the amplifying transistor ST2 illustrated in FIG. 6A.

Referring to FIGS. 8C and 8D, the second insulating layer 20 may be disposed on the first insulating layer 10 and may cover the first gate pattern layer GAT1. The second gate pattern layer GAT2 may be disposed on the second insulating layer 20. The second gate pattern layer GAT2 may include metal, an alloy, conductive metal oxide, and/or a transparent conductive material.

The second gate pattern layer GAT2 may include a fourth gate wiring G2_SRL, a fifth gate wiring G2_SCL, a sixth gate wiring G2_SIL, and an upper gate electrode UGE.

The fourth to sixth gate wirings G2_SRL, G2_SCL, and G2_SIL may extend in the first direction DR1. The fourth gate wiring G2_SRL corresponds to (or, is included in) the reset control line SRL (refer to FIG. 4A). The fifth gate wiring G2_SCL may correspond to (or, may be included in) the j-th compensation scan line SCLj (refer to FIG. 4A). The sixth gate wiring G2_SIL may correspond to (or, may be included in) the j-th initialization scan line SILj (refer to FIG. 4A).

The upper gate electrode UGE may overlap the first gate electrode G1 and may be disposed in an island shape. For example, the upper gate electrode UGE may constitute the capacitor Cst (refer to FIG. 4A) together with the first gate electrode G1. The upper gate electrode UGE may be disposed on (e.g., at) the same layer as the upper electrode UE and the lower electrode LE illustrated in FIG. 6A (that is, the second insulating layer 20). An opening UGE_OP may be formed through the upper gate electrode UGE, and the first gate electrode G1 may be partially exposed through the opening UGE_OP.

Referring to FIGS. 8D and 8E, the third insulating layer 30 may be disposed on the second insulating layer 20 and may cover the second gate pattern layer GAT2. A second semiconductor pattern layer ACT2 may be disposed on the third insulating layer 30. The second semiconductor pattern layer ACT2 may include an oxide semiconductor. The second semiconductor pattern layer ACT2 may be disposed in a layer different from the first semiconductor pattern layer ACT1 and may not overlap the first semiconductor pattern layer ACT1.

The second semiconductor pattern layer ACT2 includes a third semiconductor pattern portion P_ACT2 disposed in each of the first circuit regions P_PA and a fourth semiconductor pattern portion S_ACT2 disposed in each of the second and third circuit regions O_SA and N_O_SA.

Referring to FIGS. 8E and 8F, the fourth insulating layer 40 may be disposed on the third insulating layer 30 and may cover the second semiconductor pattern layer ACT2. The third gate pattern layer GAT3 may be disposed on the fourth insulating layer 40. The third gate pattern layer GAT3 may include metal, an alloy, conductive metal oxide, and/or a transparent conductive material.

The third gate pattern layer GAT3 may include a seventh gate wiring G3_SRL, an eighth gate wiring G3_SCL, a ninth gate wiring G3_SIL, a second horizontal initialization voltage line H_VAIL, and a first horizontal reset voltage line G3_VRL.

The seventh to ninth gate wirings G3_SRL, G3_SCL, and G3_SIL may extend in the first direction DR1. The seventh gate wiring G3_SRL may overlap the fourth semiconductor pattern portion S_ACT2. The seventh gate wiring G3_SRL may constitute the reset transistor ST1 of FIG. 4A together with the fourth semiconductor pattern portion S_ACT2. The seventh gate wiring G3_SRL may be electrically connected with the fourth gate wiring G2_SRL illustrated in FIG. 8D.

The eighth gate wiring G3_SCL may overlap the fifth gate wiring G2_SCL and the third semiconductor pattern portion P_ACT2. In one or more embodiments, the eighth gate wiring G3_SCL may make contact with the fifth gate wiring G2_SCL through a contact portion. Accordingly, the j-th compensation scan signal SCj applied to the fifth gate wiring G2_SCL may be provided to the eighth gate wiring G3_SCL. The fifth gate wiring G2_SCL, the third semiconductor pattern portion P_ACT2, and the eighth gate wiring G3_SCL may constitute the third transistor T3 of FIG. 4A.

The ninth gate wiring G3_SIL may overlap the sixth gate wiring G2_SIL and the third semiconductor pattern portion P_ACT2. The ninth gate wiring G3_SIL may be electrically connected with the sixth gate wiring G2_SIL. The j-th initialization scan signal SIj may be provided to the ninth gate wiring G3_SIL through the sixth gate wiring G2_SIL. The sixth gate wiring G2_SIL, the third semiconductor pattern portion P_ACT2, and the ninth gate wiring G3_SIL may constitute the fourth transistor T4 of FIG. 4A.

The second horizontal initialization voltage line H_VAIL may be a component included in the second initialization voltage line VAIL (refer to FIG. 4A).

Referring to FIGS. 8F and 8G, the fifth insulating layer 50 may be disposed on the fourth insulating layer 40 and may cover at least a portion of the third gate pattern layer GAT3. The first data pattern layer SD1 may be disposed on the fifth insulating layer 50. The first data pattern layer SD1 may include, for example, metal, an alloy, conductive metal oxide, and/or a transparent conductive material. Hereinafter, for convenience of description, only some of the components included in the first data pattern layer SD1 are illustrated in FIG. 8G.

The first data pattern layer SD1 may include a second horizontal reset voltage line D1_VRL, a bias voltage line D1_VBL, a first horizontal initialization voltage line H_VIL, and a first connecting electrode.

The second horizontal reset voltage line D1_VRL, the bias voltage line D1_VBL, and the first horizontal initialization voltage line H_VIL may extend in the first direction DR1. The second horizontal reset voltage line D1_VRL, the bias voltage line D1_VBL, and the first horizontal initialization voltage line H_VIL may be spaced (e.g., spaced apart) from each other in the second direction DR2.

The second horizontal reset voltage line D1_VRL may be a component included in the reset voltage line VRL of FIG. 4A. The reset voltage Vrst (refer to FIG. 4A) may be provided to the second horizontal reset voltage line D1_VRL. The second horizontal reset voltage line D1_VRL may be electrically connected with the first horizontal reset voltage line G3_VRL.

The first horizontal initialization voltage line H_VIL may be a component included in the first initialization voltage line VIL of FIG. 4A. The first initialization voltage Vint (refer to FIG. 4A) may be provided to the first horizontal initialization voltage line H_VIL. The first horizontal initialization voltage line H_VIL may be connected with the fourth transistor T4 through a contact portion. The fourth transistor T4 may receive the first initialization voltage Vint through the first horizontal initialization voltage line H_VIL.

The first connecting electrode includes a first-first connecting electrode CNE11 and a first-fourth connecting electrode CNE14. The first-first connecting electrode CNE11 may make contact with the first semiconductor pattern portion P_ACT1 (refer to FIG. 8B). The first-fourth connecting electrode CNE14 may make contact with the second sensor gate electrode STG2 (refer to FIG. 6A). The first-first connecting electrode CNE11 and the first-fourth connecting electrode CNE14 may be connected to the first semiconductor pattern portion P_ACT1 and the second sensor gate electrode STG2 through a first-first contact hole CH11 and a first-fourth contact hole CH14, respectively. The first connecting electrode may further include the first-second, first-third, first-fifth, and first-sixth connecting electrodes CNE12, CNE13, CNE15, and CNE16 illustrated in FIGS. 6A and 6B.

The first data pattern layer SD1 may further include a horizontal connecting line D1_HCL. The horizontal connecting line D1_HCL may extend in the first direction DR1. The horizontal connecting line D1_HCL may be a component used as the horizontal bridge lines H_BL or the horizontal connecting lines H_CL illustrated in FIG. 5.

Referring to FIGS. 8G and 8H, the sixth insulating layer 60 may be disposed on the fifth insulating layer 50 and may cover at least a portion of the first data pattern layer SD1. The second data pattern layer SD2 may be disposed on the sixth insulating layer 60. The second data pattern layer SD2 may include, for example, metal, an alloy, conductive metal oxide, and/or a transparent conductive material.

The second data pattern layer SD2 includes a first readout line portion RL_P1, first vertical reset voltage lines D2_VRL, a first drive voltage line VL1, and a plurality of voltage connecting patterns C_VP.

The first readout line portion RL_P1 extends in the second direction DR2 in each of the second and third circuit regions O_SA and N_O_SA. That is, in the second circuit region O_SA, the first readout line portion RL_P1 may be a portion of each of the effective readout lines illustrated in FIG. 3B. In the third circuit region N_O_SA, the first readout line portion RL_P1 may be a portion of each of the ineffective readout lines illustrated in FIG. 3B. In the second circuit region O_SA, the first readout line portion RL_P1 may be connected to the effective sensor drive circuit O_SD illustrated in FIG. 4A, and in the third circuit region N_O_SA, the first readout line portion RL_P1 may be connected to the ineffective sensor drive circuit N_O_SD illustrated in FIG. 4A.

The first vertical reset voltage lines D2_VRL extend in the second direction DR2 and are spaced (e.g., spaced apart) from each other in the first direction DR1. The first vertical reset voltage line D2_VRL may be a component included in the reset voltage line VRL of FIG. 4A. The first vertical reset voltage line D2_VRL may be connected with the first and second horizontal reset voltage lines G3_VRL and D1_VRL. The reset voltage line VRL may have a mesh shape by the coupling of the first vertical reset voltage line D2_VRL and the first and second horizontal reset voltage lines G3_VRL and D1_VRL.

The first drive voltage line VL1 may overlap the first circuit regions P_PA. The first drive voltage line VL1 may correspond to the first drive voltage line VL1 of FIG. 4A. The first drive voltage ELVDD (refer to FIG. 4A) may be provided to the first drive voltage line VL1. The first drive voltage line VL1 may be disposed in a mesh shape in the display region DA (refer to FIG. 3) of the display panel DP. The first drive voltage line VL1 may be connected with the fifth transistor T5 and the capacitor Cst, which are illustrated in FIG. 4A, through a contact portion.

The plurality of voltage connecting patterns C_VP may be connected with vertical voltage lines V_VL that will be described below.

The second data pattern layer SD2 may further include a second connecting electrode. The second connecting electrode may include a second-first connecting electrode CNE21, a second-second connecting electrode CNE22 (or, a first effective connecting electrode), and a first ineffective connecting electrode CNE22′.

In the sensing region SA, the second-first connecting electrode CNE21 and the second-second connecting electrode CNE22 may make contact with the first-first connecting electrode CNE11 and the first-fourth connecting electrode CNE14 through a second-first contact hole CH21 and a second-second contact hole CH22, respectively. In the second non-sensing region NSA2, the second-first connecting electrode CNE21 makes contact with the first-first connecting electrode CNE11, but the first ineffective connecting electrode CNE22′ does not make contact with the first-fourth connecting electrode CNE14. That is, in the sixth insulating layer 60, a contact hole (that is, the second-second contact hole CH22) for connecting the second-second connecting electrode CNE22 and the first-fourth connecting electrode CNE14 is provided, but a contact hole for connecting the first ineffective connecting electrode CNE22′ and the first-fourth connecting electrode CNE14 is not provided.

Referring to FIGS. 8H and 8I, the seventh insulating layer 70 may be disposed on the sixth insulating layer 60 and may cover at least a portion of the second data pattern layer SD2. The third data pattern layer SD3 may be disposed on the seventh insulating layer 70. The third data pattern layer SD3 may include, for example, metal, an alloy, conductive metal oxide, and/or a transparent conductive material.

The third data pattern layer SD3 may include a data wiring DL, a second readout line portion RL_P2, a second vertical reset voltage line D3_VRL, a vertical connecting wiring D3_VCL, the vertical voltage lines V_VL, and a third connecting electrode.

The data wiring DL, the second vertical reset voltage line D3_VRL, the vertical connecting wiring D3_VCL, and the vertical voltage lines V_VL may extend in the second direction DR2. The data line DL, the second vertical reset voltage line D3_VRL, the vertical connecting wiring D3_VCL, and the vertical voltage lines V_VL may be spaced (e.g., spaced apart) from each other in the first direction DR1.

The data line DL may correspond to the data lines DL1 to DLm illustrated in FIG. 3B. The data line DL may be connected to the pixel drive circuit P_PD illustrated in FIG. 4A (in particular, the second transistor T2). The vertical connecting wiring D3_VCL may be a component used as the vertical connecting lines V_CL or the vertical bridge lines V_BL illustrated in FIG. 5. The vertical connecting wiring D3_VCL may be electrically connected with the horizontal connecting line D1_HCL illustrated in FIG. 8G.

The second readout line portion RL_P2 may overlap the second and third circuit regions O_SA and N_O_SA. The second readout line portion RL_P2 may be connected with two adjacent first readout line portions RL_P1. Accordingly, one readout wiring RL may include a plurality of first and second readout line portions RL_P1 and RL_P2. The readout wiring RL may correspond to one of the readout lines RL1 to RLh illustrated in FIG. 3B.

The second vertical reset voltage line D3_VRL may be connected with the first vertical reset voltage line D2_VRL. The second vertical reset voltage line D3_VRL may be a component included in the reset voltage line VRL of FIG. 4A.

One of the vertical voltage lines V_VL may be electrically connected to the second horizontal initialization voltage line H_VAIL illustrated in FIG. 8F through a corresponding voltage connecting pattern C_VP (refer to FIG. 8H). A part of the vertical voltage lines V_VL may be used as the second initialization voltage line VAIL (refer to FIG. 4A). In addition, another one of the vertical voltage lines V_VL may be electrically connected to the first horizontal initialization voltage line H_VIL, which is illustrated in FIG. 8G, through a corresponding voltage connecting pattern C_VP (refer to FIG. 8H) and may be used as the first initialization voltage line VIL (refer to FIG. 4A).

Another one of the vertical voltage lines V_VL may be used as the second drive voltage line VL2 of FIG. 4A. As described above, the vertical voltage lines V_VL may be used as different voltage lines connected to the pixels PX (refer to FIG. 3B) and the effective and ineffective sensors FX and NFX (refer to FIG. 3B) and may alleviate a drop in the voltages applied to the respective voltage lines.

The third connecting electrode may include a third-first connecting electrode CNE31, a third-second connecting electrode CNE32 (or, a second effective connecting electrode), and a second ineffective connecting electrode CNE32′.

In the sensing region SA, the third-first connecting electrode CNE31 and the third-second connecting electrode CNE32 may make contact with the second-first connecting electrode CNE21 and the second-second connecting electrode CNE22, respectively. In the second non-sensing region NSA2, the second-first connecting electrode CNE21 and the second ineffective connecting electrode CNE32′ make contact with the first-first connecting electrode CNE11 and the first ineffective connecting electrode CNE22′, respectively. That is, in the seventh insulating layer 70, a contact hole (that is, a third-second contact hole CH32) for connecting the third-second connecting electrode CNE32 and the second-second connecting electrode CNE22 is provided, and a contact hole (that is, a third-third contact hole CH32′) for connecting the second ineffective connecting electrode CNE32′ and the first ineffective connecting electrode CNE22′ is provided.

Referring to FIGS. 8I and 8J, the eighth insulating layer 80 may be disposed on the seventh insulating layer 70 and may cover at least a portion of the third data pattern layer SD3. The transparent pattern layer TCO may be disposed on the eighth insulating layer 80. The transparent pattern layer TCO may include transparent conductive oxide. Alternatively, the transparent pattern layer TCO may include metal, an alloy, conductive metal oxide, and/or a transparent conductive material.

The transparent pattern layer TCO may include a shielding electrode RSE and a plurality of pixel connecting electrodes CNE41. In one or more embodiments of the present disclosure, the shielding electrode RSE may extend in the second direction DR2 and may overlap the readout line RL when viewed from above the plane (e.g., in a plan view). The shielding electrode RSE may make contact with the second vertical reset voltage line D3_VRL through a contact portion. Accordingly, the reset voltage Vrst (refer to FIG. 4A) applied to the second vertical reset voltage line D3_VRL may be applied to the shielding electrode RSE.

The shielding electrode RSE may be disposed to partially cover the effective and ineffective sensor drive circuits O_SD and N_O_SD in the second and third circuit regions O_SA and N_O_SA. In particular, the shielding electrode RSE may be disposed to cover all or part of the reset transistor ST1 (refer to FIG. 4A), the amplifying transistor ST2, and the output transistor ST3. The shielding electrode RSE may have an opening RSE_OP formed therein through which the effective and ineffective sensor drive circuits O_SD and N_O_SD are partially exposed.

The shielding electrode RSE may perform a shielding function such that a detection signal output from the readout wiring RL is not coupled by a data signal applied to the data wiring DL. To prevent shielding performance from being deteriorated, the opening RSE_OP may be provided in a position that does not overlap the readout wiring RL when viewed from above the plane.

The plurality of pixel connecting electrodes CNE41 may be connected to the third-first connecting electrode CNE31 (refer to FIG. 8I) in the first circuit region P_PA.

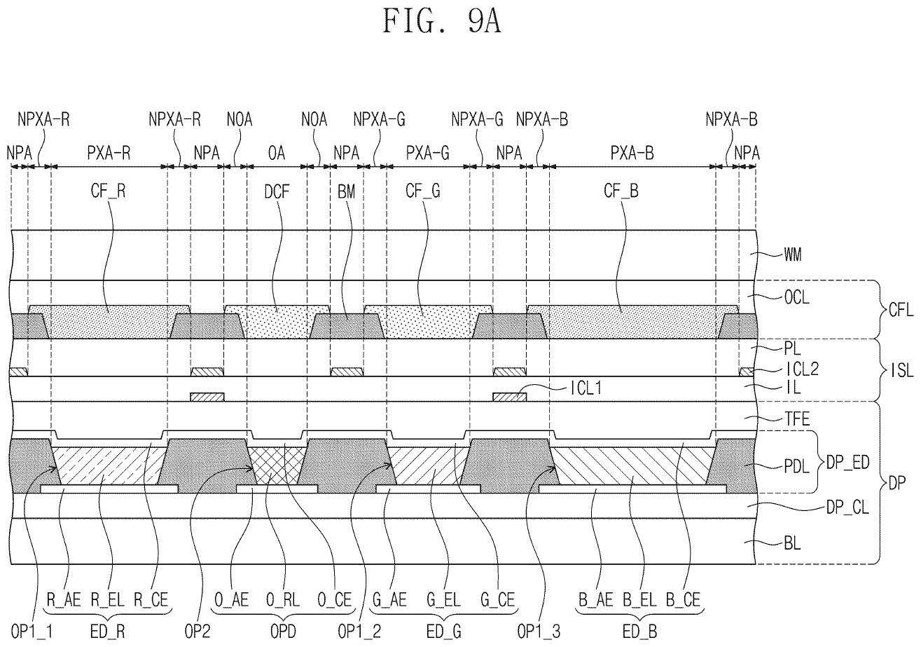

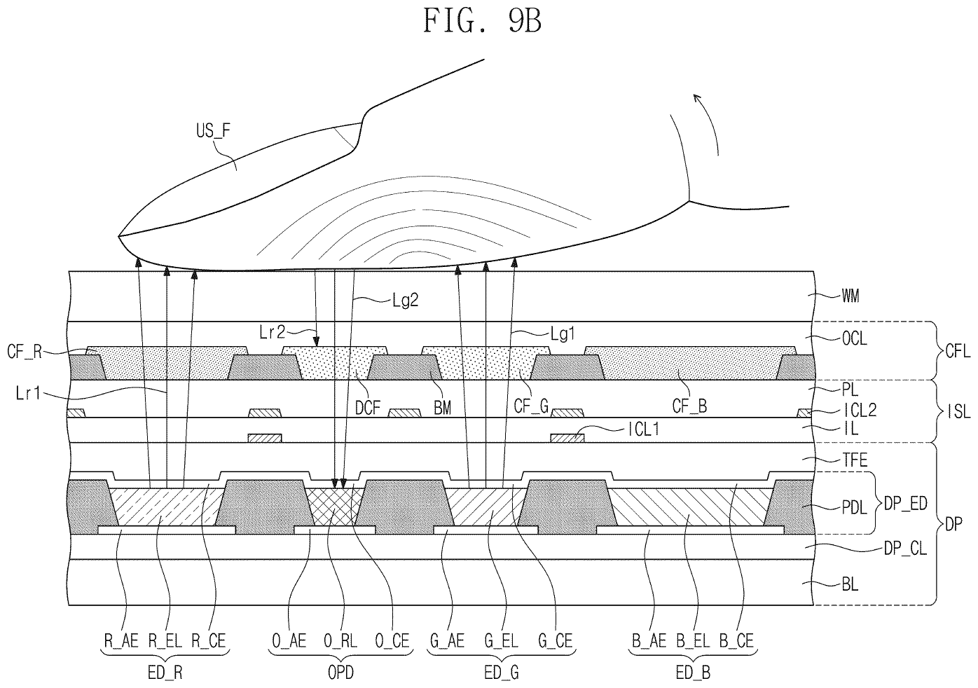

FIGS. 9A and 9B are sectional views illustrating light emitting elements and an effective light receiving element of the display panel according to one or more embodiments of the present disclosure.

Referring to FIGS. 9A and 9B, a first electrode layer is disposed on the circuit layer DP_CL. The pixel defining layer PDL is formed on the first electrode layer. The first electrode layer may include red, green, and blue anode electrodes R_AE, G_AE, and B_AE. First to third light emitting openings OP1_1, OP1_2, and OP1_3 of the pixel defining layer PDL expose at least portions of the red, green, and blue anode electrodes R_AE, G_AE, and B_AE, respectively. In one or more embodiments of the present disclosure, the pixel defining layer PDL may further include a black material. The pixel defining layer PDL may further include a black organic dye/pigment, such as carbon black, aniline black, and/or the like. The pixel defining layer PDL may be formed by mixing a blue organic material and a black organic material. The pixel defining layer PDL may further include a liquid-repellent organic material.

As illustrated in FIG. 9A, the display panel DP may include first to third emissive regions PXA-R, PXA-G, and PXA-B and first to third non-emissive regions NPXA-R, NPXA-G, and NPXA-B adjacent to the first to third emissive regions PXA-R, PXA-G, and PXA-B. The non-emissive regions NPXA-R, NPXA-G, and NPXA-B may be around (e.g., may surround) the corresponding emissive regions PXA-R, PXA-G, and PXA-B, respectively. In this embodiment, the first emissive region PXA-R is defined to correspond to a partial region of the red anode electrode R_AE exposed by the first light emitting opening OP1_1. The second emissive region PXA-G is defined to correspond to a partial region of the green anode electrode G_AE exposed by the second light emitting opening OP1_2. The third emissive region PXA-B is defined to correspond to a partial region of the blue anode electrode B_AE exposed by the third light emitting opening OP1_3. A non-pixel region NPA may be defined between the first to third non-emissive regions NPXA-R, NPXA-G, and NPXA-B.

An emissive layer may be disposed on the first electrode layer. The emissive layer may include red, green, and blue light emitting layers R_EL, G_EL, and B_EL. The red, green, and blue light emitting layers R_EL, G_EL, and B_EL may be disposed in regions corresponding to the first to third light emitting openings OP1_1, OP1_2, and OP1_3, respectively. The red, green, and blue light emitting layers R_EL, G_EL, and B_EL may be formed to be separated from one another. Each of the red, green, and blue light emitting layers R_EL, G_EL, and B_EL may include an organic material and/or an inorganic material. The red, green, and blue light emitting layers R_EL, G_EL, and B_EL may generate light of desired colors (e.g., predetermined colors). For example, the red light emitting layer R_EL may generate red light, the green light emitting layer G_EL may generate green light, and the blue light emitting layer B_EL may generate blue light.

Although the patterned red, green, and blue light emitting layers R_EL, G_EL, and B_EL are illustrated in this embodiment, one light emitting layer may be commonly disposed in the first to third emissive regions PXA_R, PXA_G, and PXA_B. In this case, the light emitting layer may generate white light or blue light. In addition, the light emitting layer may have a multi-layer structure called tandem.

Each of the red, green, and blue light emitting layers R_EL, G_EL, and B_EL may include a low molecular weight organic material and/or a high molecular weight organic material as a luminescent material. Alternatively, each of the red, green, and blue light emitting layers R_EL, G_EL, and B_EL may include a quantum-dot material as a luminescent material. A core of a quantum dot may be selected from Group II-VI compounds, Group Ill-V compounds, Group IV-VI compounds, Group IV elements, Group IV compounds, and combinations thereof.

A second electrode layer is disposed on the red, green, and blue light emitting layers R_EL, G_EL, and B_EL. The second electrode layer may include red, green, and blue cathode electrodes R_CE, G_CE, and B_CE. The red, green, and blue cathode electrodes R_CE, G_CE, and B_CE may be electrically connected with one another. In one or more embodiments of the present disclosure, the red, green, and blue cathode electrodes R_CE, G_CE, and B_CE may have a one-body shape. In this case, the red, green, and blue cathode electrodes R_CE, G_CE, and B_CE may be commonly disposed in the first to third emissive regions PXA-R, PXA-G, and PXA-B, the first to third non-emissive regions NPXA-R, NPXA-G, and NPXA-B, and the non-pixel region NPA.

The element layer DP_ED may further include the effective light receiving element OPD. The effective light receiving element OPD may be a photo diode. The pixel defining layer PDL may further include a light receiving opening OP2 provided to correspond to the effective light receiving element OPD.

The effective light receiving element OPD may include an effective anode electrode O_AE, a photoelectric conversion layer O_RL, and an effective cathode electrode O_CE. The effective anode electrode O_AE may be disposed on the same layer as the first electrode layer. That is, the effective anode electrode O_AE may be disposed on the circuit layer DP_CL and may be concurrently (e.g., simultaneously) formed through the same process as the red, green, and blue anode electrodes R_AE, G_AE, and B_AE.

The light receiving opening OP2 of the pixel defining layer PDL exposes at least a portion of the effective anode electrode O_AE. The photoelectric conversion layer O_RL is disposed on the effective anode electrode O_AE exposed by the light receiving opening OP2. The photoelectric conversion layer O_RL may include an organic photo sensing material. The effective cathode electrode O_CE may be disposed on the photoelectric conversion layer O_RL. The effective cathode electrode O_CE may be concurrently (e.g., simultaneously) formed through the same process as the red, green, and blue cathode electrodes R_CE, G_CE, and B_CE. In one or more embodiments of the present disclosure, the effective cathode electrode O_CE may be integrally formed with the red, green, and blue cathode electrodes R_CE, G_CE, and B_CE to form the common cathode electrode.

The encapsulation layer TFE is disposed on the element layer DP_ED. The encapsulation layer TFE includes at least an inorganic layer or an organic layer. In one or more embodiments of the present disclosure, the encapsulation layer TFE may include two inorganic layers and an organic layer disposed therebetween. In one or more embodiments of the present disclosure, the encapsulation layer TFE may include a plurality of inorganic layers and a plurality of organic layers alternately stacked one above another.

The inorganic layers protect the red, green, and blue light emitting elements ED_R, ED_G, and ED_B and the effective light receiving element OPD from moisture and/or oxygen, and the organic layers protect the red, green, and blue light emitting elements ED_R, ED_G, and ED_B and the effective light receiving element OPD from foreign matter such as dust particles. The inorganic layers may include a silicon nitride layer, a silicon oxy nitride layer, a silicon oxide layer, a titanium oxide layer, and/or an aluminum oxide layer, but are not particularly limited thereto. The organic layers may include an acrylic organic layer, but are not particularly limited.

The display device DD includes the input sensing layer ISL disposed on the display panel DP and the color filter layer CFL disposed on the input sensing layer ISL.

The input sensing layer ISL may be directly disposed on the encapsulation layer TFE. The input sensing layer ISL includes a first conductive layer ICL, an insulating layer IL, a second conductive layer ICL2, and a protective layer PL. The first conductive layer ICL may be disposed on the encapsulation layer TFE. Although FIGS. 9A and 9B illustrate the structure in which the first conductive layer ICL is directly disposed on the encapsulation layer TFE, the present disclosure is not limited thereto. The input sensing layer ISL may further include a base insulating layer disposed between the first conductive layer ICL and the encapsulation layer TFE. In this case, the encapsulation layer TFE may be covered by the base insulating layer, and the first conductive layer ICL may be disposed on the base insulating layer. In one or more embodiments of the present disclosure, the base insulating layer may include an inorganic insulating material.

The insulating layer IL may cover the first conductive layer ICL1. The second conductive layer ICL2 is disposed on the insulating layer IL. Although FIGS. 9A and 9B illustrate the structure in which the input sensing layer ISL includes the first and second conductive layers ICL and ICL2, the present disclosure is not limited thereto. For example, the input sensing layer ISL may include only one of the first and second conductive layers ICL and ICL2.

The protective layer PL may be disposed on the second conductive layer ICL2. The protective layer PL may include an organic insulating material. The protective layer PL may serve to protect the first and second conductive layers ICL1 and ICL2 from moisture and/or oxygen and may serve to protect the first and second conductive layers ICL1 and ICL2 from foreign matter.

The color filter layer CFL may be disposed on the input sensing layer ISL. The color filter layer CFL may be directly disposed on the protective layer PL. The color filter layer CFL may include a first color filter CF_R, a second color filter CF_G, and a third color filter CF_B. The first color filter CF_R has a first color, the second color filter CF_G has a second color, and the third color filter CF_B has a third color. In one or more embodiments of the present disclosure, the first color may be red, the second color may be green, and the third color may be blue.

The color filter layer CFL may further include a dummy color filter DCF. In one or more embodiments of the present disclosure, when the region where the photoelectric conversion layer O_RL is disposed is defined as a light receiving region OA and the region around the light receiving region OA is defined as a non-light receiving region NOA, the dummy color filter DCF may be disposed to correspond to the light receiving region OA. The dummy color filter DCF may overlap the light receiving region OA and the non-light receiving region NOA. In one or more embodiments of the present disclosure, the dummy color filter DCF may have the same color as one of the first to third color filters CF_R, CF_G, and CF_B. In one or more embodiments of the present disclosure, the dummy color filter DCF may have the same green color as the second color filter CF_G.

The color filter layer CFL may further include a black matrix BM. The black matrix BM may be disposed to correspond to the non-pixel region NPA. The black matrix BM may be disposed to overlap the first and second conductive layers ICL1 and ICL2 in the non-pixel region NPA. In one or more embodiments of the present disclosure, the black matrix BM may overlap the non-pixel region NPA and the first to third non-emissive regions NPXA-R, NPXA-B, and NPXA-B. The black matrix BM may not overlap the first to third emissive regions PXA-R, PXA-G, and PXA-B.

The color filter layer CFL may further include an overcoating layer OCL. The overcoating layer OCL may include an organic insulating material. The overcoating layer OCL may have a thickness sufficient to remove steps between the first to third color filters CF_R, CF_G, and CF_B. Without any specific limitation, the overcoating layer OCL may include any material that has a certain thickness and is capable of flattening the upper surface of the color filter layer CFL. For example, the overcoating layer OCL may include an acrylic organic material.

Referring to FIG. 9B, when the display device DD (refer to FIG. 1) operates, the red, green, and blue light emitting elements ED_R, ED_G, and ED_B may output light. The red light emitting elements ED_R output red light in a red wavelength band, the green light emitting elements ED_G output green light in a green wavelength band, and the blue light emitting elements ED_B output blue light in a blue wavelength band.

In one or more embodiments of the present disclosure, the effective light receiving element OPD may receive light from specific light emitting elements (e.g., the green light emitting elements ED_G) from among the red, green, and blue light emitting elements ED_R, ED_G, and ED_B. That is, second light Lg1 may be output from the green light emitting elements ED_G, and the effective light receiving element OPD may receive second reflected light Lg2 obtained by reflection of the second light Lg1 by the user's fingerprint. The second light Lg1 and the second reflected light Lg2 may be green light in the green wavelength band. The dummy color filter DCF is disposed over the effective light receiving element OPD. The dummy color filter DCF may be green in color. Accordingly, the second reflected light Lg2 may pass through the dummy color filter DCF and may be incident to the effective light receiving element OPD.

In one or more embodiments, the red light output from the red light emitting elements ED_R and the blue light output from the blue light emitting elements ED_B may also be reflected by the user's hand US_F. For example, when light obtained by reflection of red light Lr1 output from the red light emitting elements ED_R by the user's hand US_F is defined as first reflected light Lr2, the first reflected light Lr2 may fail to pass through the dummy color filter DCF and may be absorbed by the dummy color filer DCF. Accordingly, the first reflected light Lr2 is not able to pass through the dummy color filter DCF and is not able to be incident to the effective light receiving element OPD. Likewise, even though blue light is reflected by the user's hand US_F, the blue light may be absorbed by the dummy color filter DCF. Thus, only the second reflected light Lg2 may be provided to the effective light receiving element OPD.

As described above, the ineffective light receiving element and the ineffective sensor drive circuit in the ineffective sensor may be electrically isolated from each other. The ineffective light receiving element may not act as a load of the reset voltage line, and thus the potentials of the effective sensing node and the ineffective sensor node may be rapidly reset to the reset voltage during the reset period of the effective and ineffective sensors. That is, the time it takes the potential of the effective sensing node to be reset to the reset voltage may be reduced, and thus the overall response speed of an operation for recognizing biometric information may be improved.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A display device comprising:
a display panel including a display region and a non-display region, a plurality of pixels and a plurality of sensors being in the display region,
wherein each of the plurality of pixels comprises:
a light emitting element; and
a pixel drive circuit connected to the light emitting element,
wherein the plurality of sensors comprises first sensors in a first region of the display region and second sensors in a second region of the display region,
wherein each of the first sensors comprises:
a first light receiving element; and
a first sensor drive circuit electrically connected to the first light receiving element, and
wherein each of the second sensors comprises:
a second light receiving element; and
a second sensor drive circuit electrically isolated from the second light receiving element.

2. The display device of claim 1, wherein each of the first and second sensor drive circuits comprises:
a reset transistor connected between a reset voltage line and a sensing node;
an amplifying transistor connected to a sensor drive voltage line; and
an output transistor connected between the amplifying transistor and a readout line,
wherein the first light receiving element is electrically connected to the sensing node of the first sensor drive circuit, and
wherein the second light receiving element is electrically isolated from the second sensor drive circuit at the sensing node of the second sensor drive circuit.

3. The display device of claim 2, wherein the reset transistor comprises a first electrode connected to the reset voltage line, a second electrode connected with the sensing node, and a third electrode configured to receive a reset control signal,
wherein the amplifying transistor comprises a first electrode connected to the sensor drive voltage line, a second electrode connected with the output transistor, and a third electrode connected with the sensing node, and
wherein the output transistor comprises a first electrode connected with the second electrode of the amplifying transistor, a second electrode connected with the readout line, and a third electrode configured to receive an output control signal.

4. The display device of claim 3, wherein a first effective connecting electrode is at the sensing node of the first sensor drive circuit to electrically connect the second electrode of the reset transistor and the third electrode of the amplifying transistor, and
wherein a first ineffective connecting electrode is at the sensing node of the second sensor drive circuit and is not connected to at least one of the second electrode of the reset transistor or the third electrode of the amplifying transistor.

5. The display device of claim 4, wherein the display panel further comprises:
a first intermediate connecting electrode connected to the third electrode of the amplifying transistor of the first sensor drive circuit;
a second intermediate connecting electrode connected to the third electrode of the amplifying transistor of the second sensor drive circuit; and
a first via insulating layer, the first effective connecting electrode and the first ineffective connecting electrode being on the first via insulating layer, the first via insulating layer being on the first and second intermediate connecting electrodes.

6. The display device of claim 5, wherein a first effective contact hole exposing the first intermediate connecting electrode is in the first via insulating layer, and the first effective connecting electrode is connected to the first intermediate connecting electrode through the first effective contact hole, and
wherein the second intermediate connecting electrode is completely covered by the first via insulating layer without being exposed through a contact hole.

7. The display device of claim 4, wherein a second effective connecting electrode connected to the first effective connecting electrode is further located at the sensing node of the first sensor drive circuit, and
wherein a second ineffective connecting electrode connected to the first ineffective connecting electrode is further located at the sensing node of the second sensor drive circuit.

8. The display device of claim 7, wherein the first light receiving element comprises an effective anode electrode connected with the second effective connecting electrode of the first sensor drive circuit, and
wherein the second light receiving element comprises an ineffective anode electrode connected with the second ineffective connecting electrode of the second sensor drive circuit.

9. The display device of claim 3, wherein a first effective connecting electrode is at the sensing node of the first sensor drive circuit and connects the second electrode of the reset transistor and the third electrode of the amplifying transistor, and
wherein a first ineffective connecting electrode is at the sensing node of the second sensor drive circuit, and connects the second electrode of the reset transistor and the third electrode of the amplifying transistor.

10. The display device of claim 9, wherein a second effective connecting electrode connected to the first effective connecting electrode is at the sensing node of the first sensor drive circuit, and
wherein a second ineffective connecting electrode not connected to the first ineffective connecting electrode is at the sensing node of the second sensor drive circuit.

11. The display device of claim 10, wherein the display panel further comprises a second via insulating layer, the second effective connecting electrode and the second ineffective connecting electrode being on the second via insulating layer, the second via insulating layer being on the first effective connecting electrode and the first ineffective connecting electrode,
wherein a second effective contact hole exposing the first effective connecting electrode is in the second via insulating layer, and the second effective connecting electrode is connected to the first effective connecting electrode through the second effective contact hole, and
wherein the first ineffective connecting electrode is completely covered by the second via insulating layer without being exposed through a contact hole.

12. The display device of claim 10, wherein the first light receiving element comprises an effective anode electrode connected with the second effective connecting electrode of the first sensor drive circuit, and
wherein the second light receiving element includes an ineffective anode electrode connected with the second ineffective connecting electrode of the second sensor drive circuit.

13. The display device of claim 3, wherein the sensing node of the first sensor drive circuit comprises a first effective connecting electrode connecting the second electrode of the reset transistor and the third electrode of the amplifying transistor, and
wherein the sensing node of the second sensor drive circuit comprises a first ineffective connecting electrode connecting the second electrode of the reset transistor and the third electrode of the amplifying transistor.

14. The display device of claim 13, wherein the sensing node of the first sensor drive circuit further comprises a second effective connecting electrode connected to the first effective connecting electrode, and
wherein the sensing node of the second sensor drive circuit further comprises a second ineffective connecting electrode connected to the first ineffective connecting electrode.

15. The display device of claim 14, wherein the first light receiving element comprises an effective anode electrode connected with the second effective connecting electrode of the first sensor drive circuit, and
wherein the second light receiving element comprises an ineffective anode electrode not connected with the second ineffective connecting electrode of the second sensor drive circuit.

16. The display device of claim 1, wherein the display panel further comprises a third via insulating layer, the effective anode electrode and the ineffective anode electrode are on the third via insulating layer, the third via insulating layer being on the second effective connecting electrode and the second ineffective connecting electrode,
wherein a third effective contact hole exposing the second effective connecting electrode is in the third via insulating layer, and the effective anode electrode is connected to the second effective connecting electrode through the third effective contact hole, and
wherein the second ineffective connecting electrode is completely covered by the third via insulating layer without being exposed through a contact hole.

17. The display device of claim 2, wherein the reset voltage line is commonly connected to the first and second sensor drive circuits,
wherein the reset transistors of the first and second sensor drive circuits are concurrently turned on during a reset period, and
wherein a reset voltage applied to the reset voltage line is applied to the sensing node through the turned-on reset transistors during the reset period.

18. The display device of claim 1, wherein the first region is a sensing region configured to sense biometric information,
wherein the second region is a non-sensing region configured so as not to sense the biometric information, and
wherein the second region comprises:
a first non-sensing region on a first side of the first region; and
a second non-sensing region on a second side of the first region, the second side facing away from the first side of the first region.

19. The display device of claim 1, wherein the display panel further comprises:
readout lines connected to the sensors, and
wherein the display device further comprises:
a readout chip electrically connected to effective readout lines from among the readout lines, the effective readout lines being in the first region and connected to the first sensors.

20. The display device of claim 19, wherein the readout chip is not electrically connected with ineffective readout lines from among the readout lines, the ineffective readout lines being in the second region and connected to the second sensors.
